(19) United States
(12) Patent Application Publication
(10) Pub. No.: US 2025/0313030 A1
(43) Pub. Date: Oct. 9, 2025

(54) POST-PROCESSING APPARATUS AND BOOKLET

(71) Applicant: GRADCO JAPAN LTD., Machida-shi, Tokyo (JP)

(72) Inventor: Kazushige MASUNARI, Machida-shi, Tokyo (JP)

(21) Appl. No.: 18/714,574

(22) PCT Filed: Nov. 29, 2022
(86) PCT No.: PCT/JP2022/044075

§ 371 Date: Oct. 22, 2024

(30) Foreign Application Priority Data
Dec. 7, 2021 (JP) 2021-198918

(51) Int. Cl. B42C 19/02; B26F 1/12; B42C 1/10; B65H 33/04; B65H 37/04

(52) U.S. Cl. CPC B42C 19/02; B26F 1/12; B42C 1/10; B65H 33/04; B65H 37/04

(57) ABSTRACT

[Problem] With a simple configuration, bookbinding can be performed such that a document sheet can be identified for each chapter by an index sheet, and a predetermined sheet can be easily turned over and opened.

[Solution] A post-processing apparatus adapted to cause a document sheet S1 having a document formed thereon and an index sheet S2 having a chapter title formed thereon to overlap each other, and to perform bookbinding such that the document sheet S1 is identifiable for each chapter by the index sheet S2, the post-processing apparatus including: an image formation unit configured to form, based on a title setting function provided in document generation software, the chapter title on the index sheet S2 according to chapter title information attached to the document; a processing formation unit 30 configured to form a cut-out or cuttable portion-to-be-processed K on the document sheet S1; and a bookbinding unit 40 configured to cause the document sheet S1 having the portion-to-be-processed K formed thereon and the index sheet S2 having the chapter title formed thereon to overlap each other such that the document sheet S1 is positioned on the index sheet S2, and to perform the bookbinding by causing the portion-to-be-processed K of the document sheet S1 and the chapter title of the index sheet S2 to coincide with each other.

### TECHNICAL FIELD

The present invention relates to a post-processing apparatus that generates a booklet including a sheet on which a document is printed and an index sheet, and the booklet obtained by binding document sheets each having the document formed thereon.

### BACKGROUND ART

Conventionally, when a booklet is obtained by binding a plurality of sheets, there are several types of bookbinding such as bookbinding by punching holes in a bundle of sheets, bookbinding using a binding needle, saddle bookbinding by binding the center portions of a bundle of sheets, gluing bookbinding by applying an adhesive to the back of a bundle of sheets, and bookbinding using a binding tape.

In addition, for example, Patent Literature 1 and Patent Literature 2 describe that an insert mechanism that feeds an index sheet of tab paper and inserts the index sheet into a space between document sheets is provided. Further, Patent Literature 3 describes that a cut is made at a sheet end portion, and the cut portion is folded back to form a tab.
Patent Literature 1: JP 2002-152442 A
Patent Literature 2: JP 2003-40517 A
Patent Literature 3: JP H09-175725 A

### SUMMARY OF INVENTION

### Technical Problem

As described above, there are various binding methods for bookbinding, but there is no binding method in which a title is printed according to title style information attached to a document to generate an index sheet, and the index sheet is inserted to be bound. In addition, there is a method of simply inserting an index sheet, but the index sheet is simply inserted to classify sheets.

The present invention has been made in view of such circumstances of the prior art, and an object of the present invention is to provide a post-processing apparatus capable of binding document sheets such that the document sheets can be identified for each chapter by index sheets with a simple configuration and capable of easily turning over and opening a predetermined sheet, and a booklet obtained by binding the document sheets each having a document formed thereon.

### Solution to Problem

To solve the above-described problems and achieve the object, the present invention is configured as follows.

The invention according to claim 1 is
a post-processing apparatus that causes a document sheet having a document formed thereon and an index sheet having a chapter title formed thereon to overlap each other, and performs bookbinding such that the document sheet is identifiable for each chapter by the index sheet, the post-processing apparatus including:
   an image formation unit configured to form the chapter title on the index sheet according to chapter title information attached to the document based on a title setting function provided in document generation software;
   a processing formation unit configured to form a cut-out or cuttable portion-to-be-processed on the document sheet; and
   a bookbinding unit configured to cause the document sheet having the portion-to-be-processed formed thereon and the index sheet having the chapter title formed thereon to overlap each other such that the document sheet is positioned on the index sheet, and to perform the bookbinding while causing the portion-to-be-processed of the document sheet and the chapter title of the index sheet to coincide with each other.

The invention according to claim 2 is
a post-processing apparatus that causes a document sheet having a document formed thereon and an index sheet having a chapter title formed thereon to overlap each other, and performs bookbinding such that the document sheet is identifiable for each chapter by the index sheet, the post-processing apparatus including:
   a colored portion included in the document sheet and the index sheet, the colored portion being capable of distinguishing chapters by different colors;
   an image formation unit configured to form the chapter title at the colored portion of the index sheet according to chapter title information attached to the document based on a title setting function provided in document generation software;
   a processing formation unit configured to form a cut-out or cuttable portion-to-be-processed at the colored portion of the document sheet; and
   a bookbinding unit configured to cause the document sheet having the portion-to-be-processed formed thereon and the index sheet having the chapter title formed thereon to overlap each other such that the document sheet is positioned on the index sheet, and to perform the bookbinding while causing the portion-to-be-processed of the document sheet and the chapter title of the index sheet to coincide with each other.

The invention according to claim 3 is
a post-processing apparatus that causes a document sheet having a document formed thereon and an index sheet having a chapter title formed thereon to overlap each other, and performs bookbinding such that the document sheet is identifiable for each chapter by the index sheet, the post-processing apparatus including:
   an image formation unit configured to form the chapter title on the index sheet according to chapter title information attached to the document based on a title setting function provided in document generation software;
   a processing formation unit configured to form a cut-out or cuttable portion-to-be-processed on the document sheet and to form the cut-out or cuttable portion-to-be-processed on the index sheet; and
   a bookbinding unit configured to cause the document sheet having the portion-to-be-processed formed thereon and the index sheet having the chapter title formed thereon to overlap each other such that the document sheet is positioned on the index sheet, and to perform the bookbinding while causing the portion-to-be-processed of the document sheet and the chapter title of the index sheet to coincide with each other.

The invention according to claim 4 is
a post-processing apparatus that causes a document sheet having a document formed thereon and an index sheet having a chapter title formed thereon to overlap each other, and performs bookbinding such that the document sheet is identifiable for each chapter by the index sheet, the post-processing apparatus including:
   a colored portion included in the document sheet and the index sheet, the colored portion being capable of distinguishing chapters by different colors;
   an image formation unit configured to form the chapter title at the colored portion of the index sheet according to chapter title information attached to the document based on a title setting function provided in document generation software;
   a processing formation unit configured to form a cut-out or cuttable portion-to-be-processed at the colored portion of the document sheet and to form the cut-out or cuttable portion-to-be-processed at the colored portion of the index sheet; and
   a bookbinding unit configured to cause the document sheet having the portion-to-be-processed formed thereon and the index sheet having the chapter title formed thereon to overlap each other such that the document sheet is positioned on the index sheet, and to perform the bookbinding while causing the portion-to-be-processed of the document sheet and the chapter title of the index sheet to coincide with each other.

The invention according to claim 5 is
a post-processing apparatus that causes a document sheet having a document formed thereon and an index sheet having a chapter title formed thereon to overlap each other, and performs bookbinding such that the document sheet is identifiable for each chapter by the index sheet, the post-processing apparatus including:
   an image formation unit configured to form the chapter title on the index sheet according to chapter title information attached to the document based on a title setting function provided in document generation software;
   a cutting unit configured to obtain the index sheet having the chapter title and to cut the document sheet according to a size of the index sheet; and
   a bookbinding unit configured to perform the bookbinding by overlapping the index sheet and the document sheet.

The invention according to claim 6 is
a post-processing apparatus that causes a document sheet having a document formed thereon and an index sheet having a chapter title formed thereon to overlap each other, and performs bookbinding such that the document sheet is identifiable for each chapter by the index sheet, the post-processing apparatus including:
   an image formation unit configured to form the chapter title on the index sheet according to chapter title information attached to the document based on a title setting function provided in document generation software;
   a sheet generation unit configured to divide a central position of a sheet into two to obtain the index sheet having a protruding chapter title and the document sheet having a notch formed by the protruding chapter title; and
   a bookbinding unit configured to switch the index sheet having the protruding chapter title and the document sheet having the notch such that the notch of the document sheet faces a side opposite to the protruding chapter title of the index sheet, and to perform the bookbinding by overlapping the index sheet and the document sheet such that the index sheet is positioned on the document sheet.

The invention according to claim 7 is
a post-processing apparatus that causes a document sheet having a document formed thereon and an index sheet having a chapter title formed thereon to overlap each other, and performs bookbinding such that the document sheet is identifiable for each chapter by the index sheet, the post-processing apparatus including:
   an image formation unit configured to form the chapter title at a central position of the index sheet according to chapter title information attached to the document based on a title setting function provided in document generation software;
   an index sheet generation unit configured to form a notch around the chapter title formed at the central position of the index sheet and to fold the sheet in two to obtain the index sheet having the chapter title; and
   a bookbinding unit configured to perform the bookbinding by overlapping the index sheet and the document sheet such that the index sheet is positioned on the document sheet.

The invention according to claim 8 is
the post-processing apparatus according to any one of claims 1 to 4, in which
the processing formation unit includes
   a blade that forms a plurality of the cut-out or cuttable portions-to-be-processed corresponding to a position at which the portion-to-be-processed on the document sheet is to be formed, and
   each of the plurality of blades moves based on selection to form the portion-to-be-processed on the document sheet at a predetermined position.

The invention according to claim 9 is
a post-processing apparatus that performs bookbinding such that a plurality of sheets are identifiable, the post-processing apparatus including:
   a notch unit configured to form a protruding title by changing a notched position one by one for the plurality of sheets; and
   a bookbinding unit configured to bind the plurality of sheets each having the protruding title formed thereon such that the protruding titles are arranged one by one.

The invention according to claim 10 is
a booklet obtained by causing a document sheet having a document formed thereon and an index sheet having a chapter title formed thereon to overlap each other and performing bookbinding such that the document sheet is identifiable for each chapter by the index sheet, in which
a cut-out or cuttable portion-to-be-processed is formed on the document sheet, and
the document sheet having the portion-to-be-processed formed thereon and the index sheet having the chapter title formed thereon overlap each other such that the document sheet is positioned on the index sheet, and the bookbinding is performed while causing the portion-to-be-processed of the document sheet and the chapter title of the index sheet to coincide with each other.

The invention according to claim 11 is
a booklet obtained by causing a document sheet having a document formed thereon and an index sheet having a chapter title formed thereon to overlap each other and performing bookbinding such that the document sheet is identifiable for each chapter by the index sheet, in which
the document sheet and the index sheet include a colored portion capable of distinguishing chapters by different colors,
the chapter title is formed at the colored portion of the index sheet,
a cut-out or cuttable portion-to-be-processed is formed at the colored portion of the document sheet, and
the document sheet having the portion-to-be-processed formed thereon and the index sheet having the chapter title formed thereon overlap each other such that the document sheet is positioned on the index sheet, and the bookbinding is performed while causing the portion-to-be-processed of the document sheet and the chapter title of the index sheet to coincide with each other.

The invention according to claim 12 is
a booklet obtained by causing a document sheet having a document formed thereon and an index sheet having a chapter title formed thereon to overlap each other and performing bookbinding such that the document sheet is identifiable for each chapter by the index sheet, in which
the chapter title is formed on the index sheet,
a cut-out or cuttable portion-to-be-processed is formed on the document sheet, and the cut-out or cuttable portion-to-be-processed is formed on the index sheet, and
the document sheet having the portion-to-be-processed formed thereon and the index sheet having the chapter title formed thereon overlap each other such that the document sheet is positioned on the index sheet, and the bookbinding is performed while causing the portion-to-be-processed of the document sheet and the chapter title of the index sheet to coincide with each other.

The invention according to claim 13 is
a booklet obtained by causing a document sheet having a document formed thereon and an index sheet having a chapter title formed thereon to overlap each other and performing bookbinding such that the document sheet is identifiable for each chapter by the index sheet, in which
the document sheet and the index sheet include a colored portion capable of distinguishing chapters by different colors,
the chapter title is formed at the colored portion of the index sheet,
a cut-out or cuttable portion-to-be-processed is formed at the colored portion of the document sheet, and the cut-out or cuttable portion-to-be-processed is formed at the colored portion of the index sheet, and
the document sheet having the portion-to-be-processed formed thereon and the index sheet having the chapter title formed thereon overlap each other such that the document sheet is positioned on the index sheet, and the bookbinding is performed while causing the portion-to-be-processed of the document sheet and the chapter title of the index sheet to coincide with each other.

The invention according to claim 14 is
a booklet obtained by bookbinding document sheets each having a document formed thereon, in which
a portion-to-be-processed including holes formed along a line is provided
on a binding side of the booklet or an opening side of the booklet.

### Advantageous Effects of Invention

With the above-described configuration, the present invention has the following effects.

In the invention according to any one of claims 1 to 8, it is possible to generate, based on the title style setting function provided in the document generation software, the document sheet having the document formed thereon and the index sheet having the chapter title formed thereon according to the title style information attached to the document, and to perform bookbinding such that the document sheet is identifiable for each chapter by the index sheet with a simple configuration.

In the invention according to claim 9, bookbinding is performed by overlapping the plurality of sheets having the protruding titles formed thereon such that the protruding titles are arranged one by one, whereby the plurality of sheets can be easily turned over one by one by the titles protruding one by one.

In the invention according to claims 10 to 13, the document sheet having the document formed thereon and the index sheet having the chapter title formed thereon are generated according to the title style information attached to the document, and bookbinding is performed such that the document sheet is identifiable for each chapter by the index sheet with a simple configuration.

In the invention according to claim 14, the plurality of sheets can be easily turned over one by one, and reliable bookbinding can be performed.

### BRIEF DESCRIPTION OF DRAWINGS

FIG. 1 is a schematic diagram of main parts of a post-processing apparatus according to a first embodiment.

FIG. 2 is a schematic configuration diagram of the entire post-processing apparatus.

FIG. 3 is a diagram illustrating a combination of document sheets and index sheets.

FIG. 4 is a diagram illustrating the document sheets and the index sheets of bookbinding.

FIGS. 5A and 5B are diagrams illustrating a booklet.

FIGS. 6A to 6C are diagrams illustrating a form of a cut-out or cuttable portion-to-be-processed.

FIGS. 7A to 7F are diagrams illustrating a configuration of a processing formation unit.

FIG. 8 is a schematic diagram of main parts of a post-processing apparatus according to a second embodiment.

FIG. 9 is a diagram illustrating a combination of document sheets and index sheets.

FIG. 10 is a diagram illustrating the document sheets and the index sheets of bookbinding.

FIGS. 11A and 11B are diagrams illustrating a booklet.

FIG. 12 is a schematic diagram of main parts of a post-processing apparatus according to a third embodiment.

FIG. 13 is a diagram illustrating a combination of document sheets and index sheets.

FIGS. 14A and 14B are diagrams illustrating the document sheets and the index sheets of bookbinding.

FIG. 15 is a plan view of a booklet.

FIG. 16 is a schematic diagram of main parts of a post-processing apparatus according to a fourth embodiment.

FIG. 17 is a diagram illustrating a combination of document sheets and index sheets.

FIGS. 18A and 18B are diagrams illustrating the document sheets and the index sheets of bookbinding.

FIG. 19 is a diagram illustrating a booklet.

FIG. 20 is a schematic diagram of main parts of a post-processing apparatus according to a fifth embodiment.

FIGS. 21A and 21B are diagrams illustrating document sheets and index sheets.

FIG. 22 is a diagram illustrating bookbinding.

FIG. 23 is a schematic diagram of main parts of a post-processing apparatus according to a sixth embodiment.

FIGS. 24A to 24D are diagrams illustrating document sheets and index sheets.

FIG. 25 is a diagram illustrating bookbinding.

FIG. 26 is a schematic diagram of main parts of a post-processing apparatus according to a seventh embodiment.

FIG. 27 is a diagram illustrating document sheets and index sheets.

FIGS. 28A to 28C are diagrams illustrating generation of the index sheet.

FIG. 29 is a diagram illustrating the document sheets and the index sheets of bookbinding.

FIG. 30 is a plan view of a booklet.

FIG. 31 is a schematic diagram of main parts of a post-processing apparatus according to an eighth embodiment.

FIG. 32 is a diagram illustrating generated sheets.

FIGS. 33A to 33C are diagrams illustrating bookbinding of sheets.

FIGS. 34A and 34B are diagrams illustrating a state in which a document sheet of a booklet according to a ninth embodiment is opened.

### DESCRIPTION OF EMBODIMENTS

Hereinafter, embodiments of a post-processing apparatus according to the present invention will be described. The embodiment of the present invention shows the most preferable form of the invention, and the present invention is not limited thereto.

### First Embodiment

### Post-Processing Apparatus

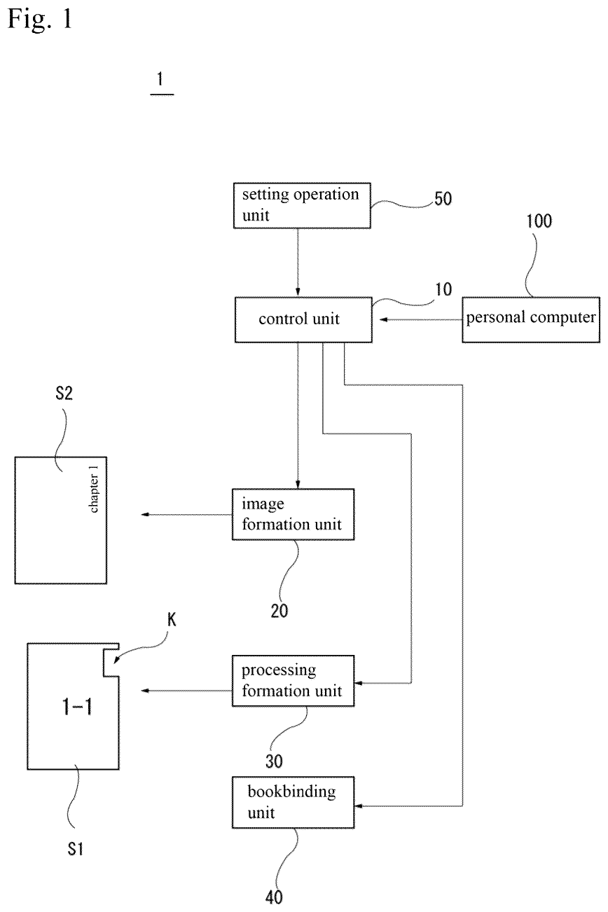

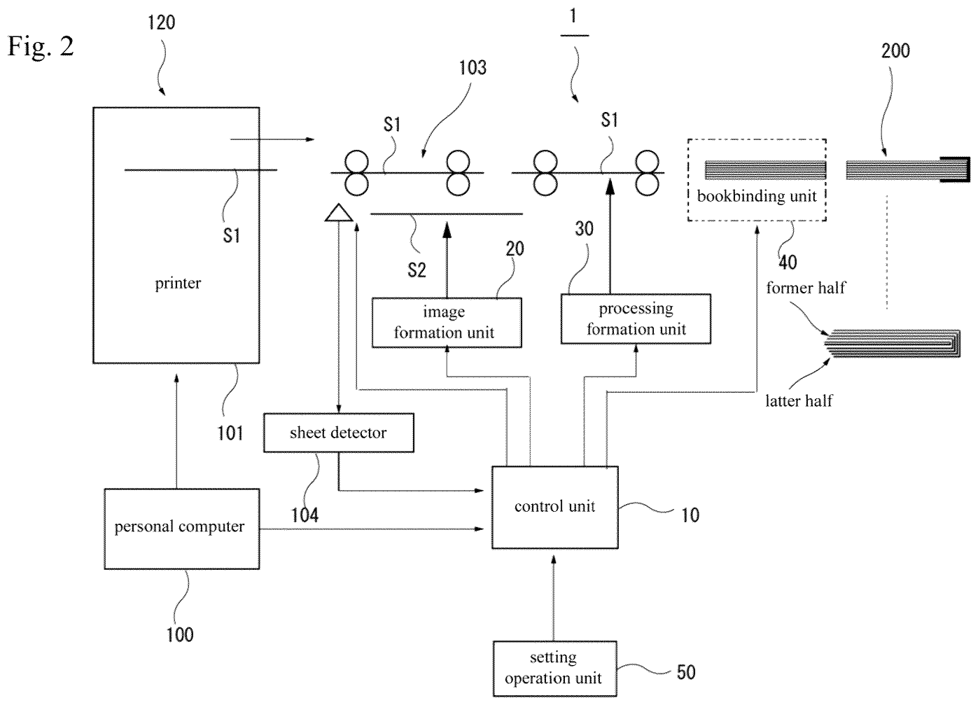

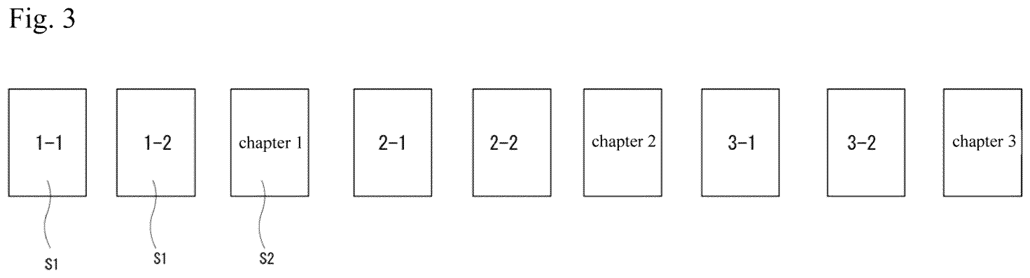

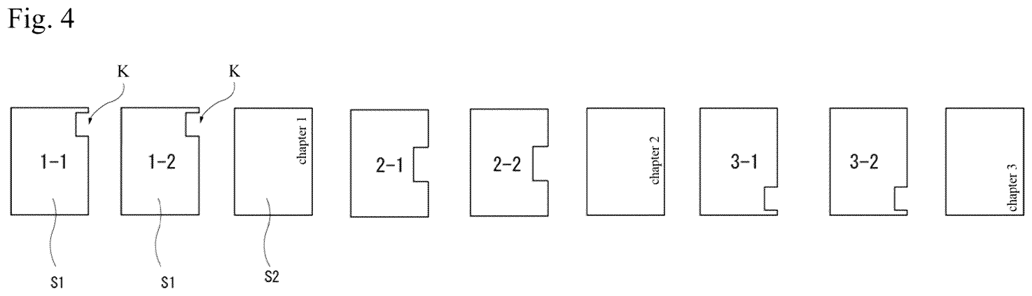

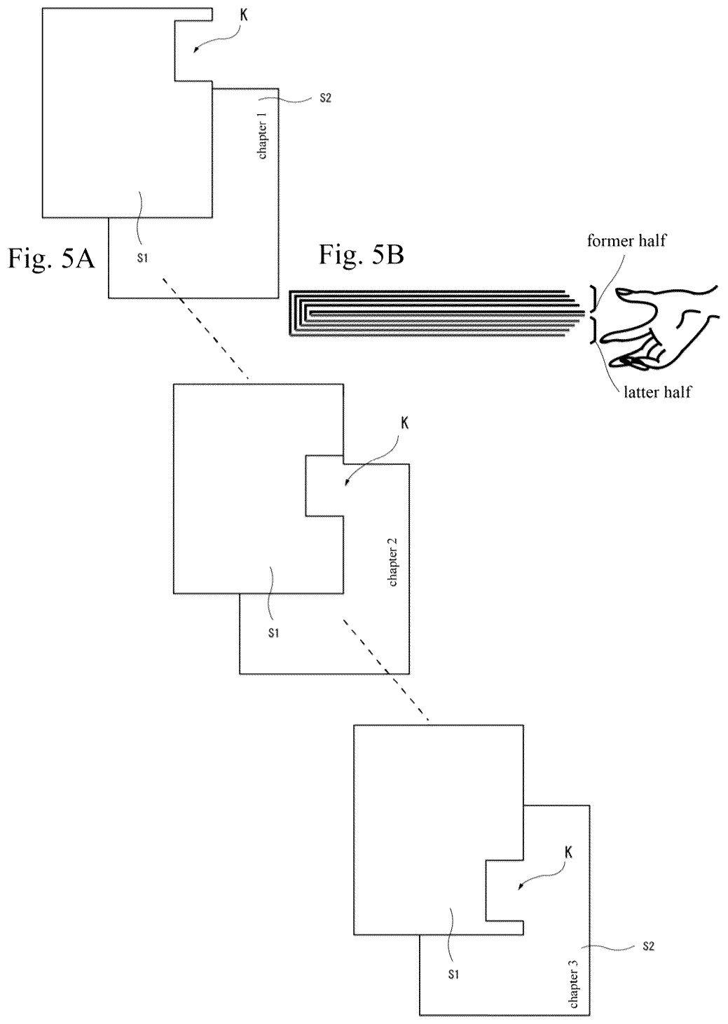

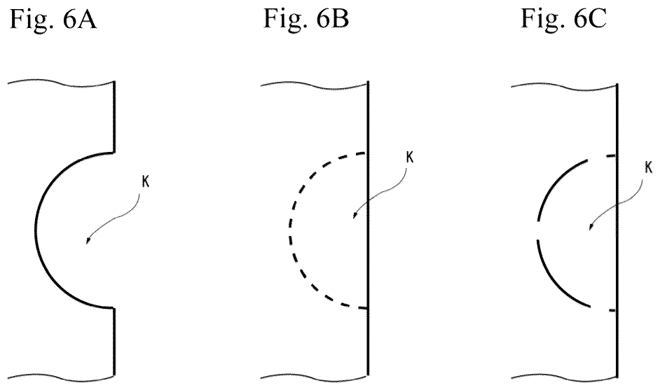

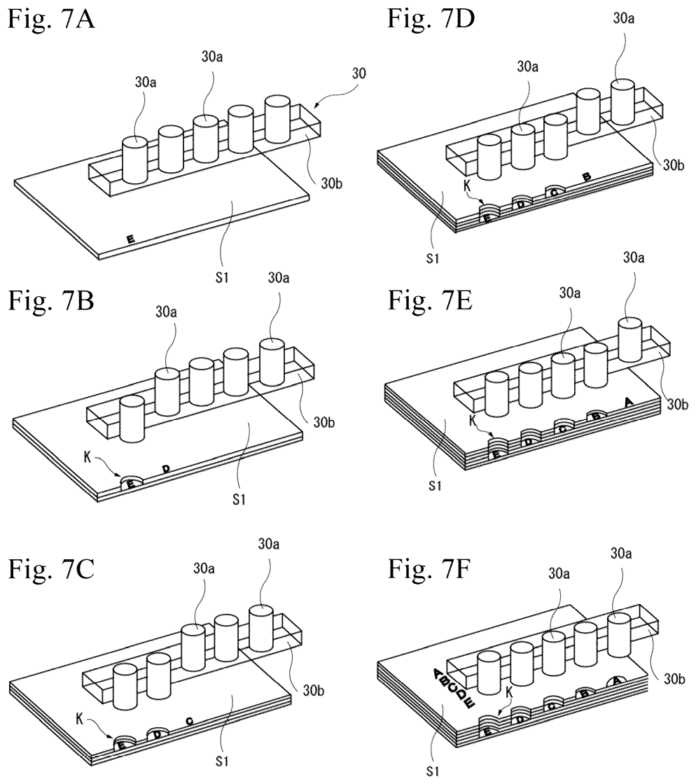

A post-processing apparatus will be described with reference to FIGS. 1 to 7. FIG. 1 is a schematic diagram of main parts of a post-processing apparatus, FIG. 2 is a schematic configuration diagram of the entire post-processing apparatus, FIG. 3 is a diagram illustrating a combination of document sheets and index sheets, FIG. 4 is a diagram illustrating the document sheets and the index sheets of bookbinding, FIGS. 5A and 5B are diagrams illustrating a booklet, FIGS. 6A to 6C are diagrams illustrating a form of a cut-out or cuttable portion-to-be-processed, and FIGS. 7A to 7F are diagrams illustrating a configuration of a processing formation unit.

The post-processing apparatus 1 is an apparatus that overlaps a document sheet S1 on which a document is formed and an index sheet S2 on which a chapter title is formed, and performs bookbinding such that the document sheet S1 can be identified for each chapter by the index sheet S2.

The post-processing apparatus 1 includes a control unit 10, an image formation unit 20, a processing formation unit 30, and a bookbinding unit 40, and the control unit 10 controls the image formation unit 20, the processing formation unit 30, and the bookbinding unit 40 based on information from a setting operation unit 50 and a personal computer 100.

The personal computer 100 has document generation software displayed on a display device, and the document generation software has a title style setting function. The control unit 10 is configured to control the image formation unit 20, the processing formation unit 30, and the bookbinding unit 40 based on a setting of a title style by the title style setting function of the document generation software or the setting operation unit 50, to overlap the document sheet S1 on which the document is formed and the index sheet S2 on which the chapter title is formed, and to perform bookbinding such that the document sheet S1 can be identified for each chapter by the index sheet S2, thereby producing a booklet.

The image formation unit 20 forms the chapter title on the index sheet S2 according to chapter title information attached to the document based on the title setting function of the document generation software, and the processing formation unit 30 forms a cut-out or cuttable portion-to-be-processed K on the document sheet S1.

The portion-to-be-processed K has a rectangular cut, but may be a semicircular shape or the like as illustrated in FIG. 6A, and is not particularly limited. In addition, the portion-to-be-processed K may be configured to be able to be cut out, thus in FIG. 6B, the portion-to-be-processed K is configured to be able to be cut out with perforations, and in FIG. 6C, the portion-to-be-processed K is configured to be able to be cut out with three remaining points. Since the portion-to-be-processed K is configured to be cuttable, a user can cut a booklet when using the booklet or use the booklet without cutting the booklet, and as a result, for example, it is possible to suppress generation of cutout dust inside a generation device.

The bookbinding unit 40 causes the document sheet S1 on which the portion-to-be-processed K is formed and the index sheet S2 on which the chapter title is formed to overlap each other such that the document sheet S1 is positioned on the index sheet S2, and performs bookbinding while causing the portion-to-be-processed K of the document sheet S1 and the chapter title of the index sheet S2 to coincide with each other.

For example, as illustrated in FIG. 4, the image formation unit 20 generates a plurality of index sheets S2 on which chapter titles of Chapter 1, Chapter 2, and Chapter 3 are formed. The index sheets S2 forming the chapter titles of Chapter 1, Chapter 2, and Chapter 3respectively have different positions of the formed chapter titles of Chapter 1, Chapter 2, and Chapter 3.

For example, the processing formation unit 30 forms the portion-to-be-processed K on the document sheet S1 such that the document sheet S1 on which the document is formed can be identified for each chapter. The positions of the portions-to-be-processed K of the document sheets S1 respectively coincide with the positions of the chapter titles of Chapter 1, Chapter 2, and Chapter 3 respectively formed on the index sheets S2.

For example, as illustrated in FIGS. 5A and 5B, the bookbinding unit 40 causes the document sheet S1 on which the portion-to-be-processed K is formed at a position coinciding with the position of the chapter title of Chapter 1 and the index sheet S2 on which the chapter title of Chapter 1 is formed to overlap each other such that the document sheet S1 is positioned on the index sheet S2, causes the document sheet S1 on which the portion-to-be-processed K is formed at a position coinciding with the position of the chapter title of Chapter 2 and the index sheet S2 on which the chapter title of Chapter 2 is formed to overlap each other such that the document sheet S1 is positioned on the index sheet S2, and similarly, sequentially causes the portion-to-be-processed K of the document sheet S1 and the chapter title of the index sheet S2 to coincide with each other to perform bookbinding.

For example, as illustrated in FIG. 2, the post-processing apparatus 1 is connected to an image forming apparatus 120, and inserts the index sheet S2 into a space between the plurality of document sheets S1 under the control of the control unit 10 to perform bookbinding, thereby obtaining a booklet 200 of sheets.

The image forming apparatus 120 includes, for example, a printer 101, connects the printer 101 to the personal computer 100, performs printing from the document generation software displayed on the display device of the personal computer 100, and sends the document sheet S1 on which an image is printed to the post-processing apparatus 1 via a sheet conveyance unit 103.

The sheet conveyance unit 103 includes a conveyance roller, a conveyance guide, and the like, and conveys the document sheet S1 on which the image is printed by the document generation software in the printer 101, and sends the document sheet S1 to the bookbinding unit 40. A sheet detector 104 is disposed in the sheet conveyance unit 103, and transmits sheet detection information to the control unit 10. The control unit 10 controls the sheet conveyance unit 103, the image formation unit 20, the processing formation unit 30, and the bookbinding unit 40 based on the sheet detection information. The image formation unit 20 of the present embodiment has a configuration different from that of the printer 101, but may be configured by the printer 101.

The bookbinding unit 40, as illustrated in FIGS. 5A and 5B, causes the document sheet S1 on which the portion-to-be-processed K is formed and the index sheet S2 on which the chapter title is formed to overlap each other such that the document sheet S1 is positioned on the index sheet S2, and the portion-to-be-processed K of the document sheet S1 and the chapter title of the index sheet S2 are caused to coincide with each other to perform bookbinding, thereby obtaining the booklet 200. The bookbinding can be utilized in various ways, such as tape bookbinding, staple needle bookbinding, ring bookbinding, case bookbinding, gluing bookbinding, perforation-only bookbinding, and binding bookbinding by punching. In the present embodiment, in the case of saddle-stitch bookbinding, there is an advantage in that the latter half pages of the booklet 200 are also easily turned over by the portion-to-be-processed K of the document sheet S1.

As described above, the document sheet S1 on which the document is formed and the index sheet S2 on which the chapter title is formed are generated according to the title style information attached to the document based on the title style setting function of the document generation software, and bookbinding can be performed such that the document sheet S1 can be identified for each chapter by the index sheet S2 with a simple configuration.

### Configuration of Processing Formation Unit

The processing formation unit 30 can be configured as illustrated in FIGS. 7A to 7F. The processing formation unit 30 of the present embodiment includes a plurality of blades 30a respectively corresponding to the positions of the portions-to-be-processed K of the document sheet S1. The plurality of blades 30a are supported by a base 30b, and each of the blades 30a is moved based on selection and is moved to a predetermined position, thereby forming the portion-to-be-processed K on the document sheet S1.

In the present embodiment, bookbinding of a booklet including Chapters A to E is illustrated. In FIG. 7A, all pages of the document sheet S1 of Chapter E are stacked without being partially cut off. In FIG. 7B, one blade 30a is selected to partially cut out and stack all pages of the document sheet S1 of Chapter D. In FIG. 7C, two blades 30a are selected to partially cut out and stack all pages of the document sheet S1 of Chapter C. In FIG. 7D, three blades 30a are selected to partially cut out and stack all pages of the document sheet S1 of Chapter B. In FIG. 7E, four blades 30a are selected to partially cut out and stack all pages of the document sheet S1 of Chapter A. In FIG. 7F, five blades 30a are selected to partially cut out and stack all pages of the document sheet S1 of a table of contents or the like.

The processing formation unit 30 is not limited to the configuration illustrated in FIGS. 7A to 7F, and may be formed by moving a single blade to a predetermined position and cutting out a part of the document sheet S1.

### Booklet

In the booklet, as illustrated in FIGS. 5A and 5B, the document sheet S1 on which the document is formed and the index sheet S2 on which the chapter title is formed are caused to overlap each other, and bookbinding is performed such that the document sheet S1 can be identified for each chapter by the index sheet S2. The cut-out or cuttable portion-to-be-processed K is formed on the document sheet S1, the document sheet S1 on which the portion-to-be-processed K is formed overlaps the index sheet S2 on which the chapter title is formed such that the document sheet S1 is positioned on the index sheet S2 on which the chapter title is formed, and the portion-to-be-processed K of the document sheet S1 and the chapter title of the index sheet S2 are caused to coincide with each other, thereby performing bookbinding.

In the booklet, the document sheet S1 on which the document is formed and the index sheet S2 on which the chapter title is formed can be generated according to the title style information attached to the document, and bookbinding can be performed such that the document sheet S1 can be identified for each chapter by the index sheet S2 with a simple configuration.

### Second Embodiment

### Post-Processing Apparatus

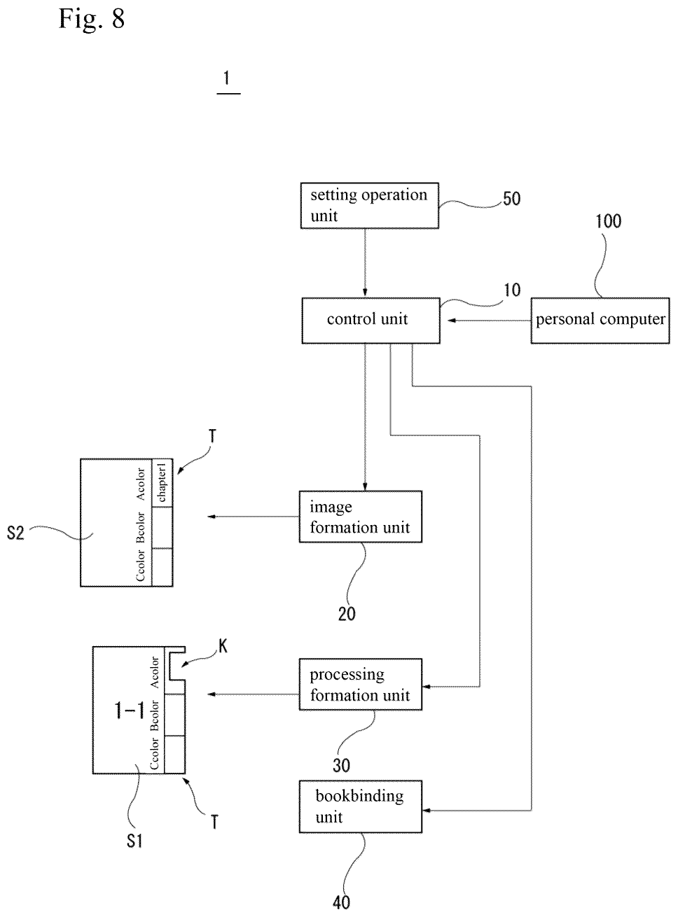

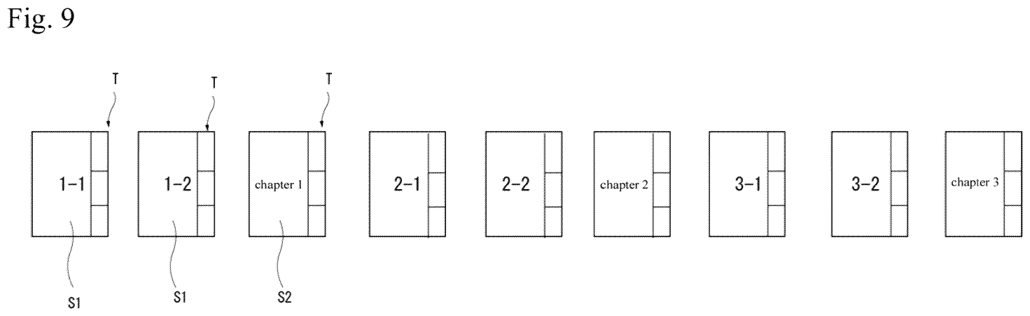

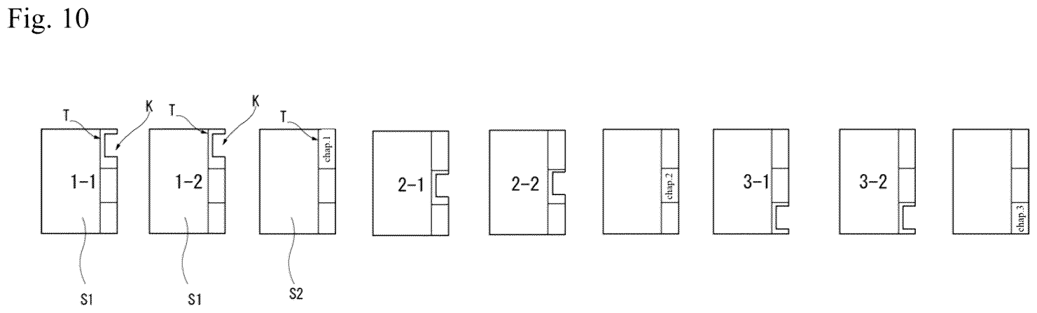

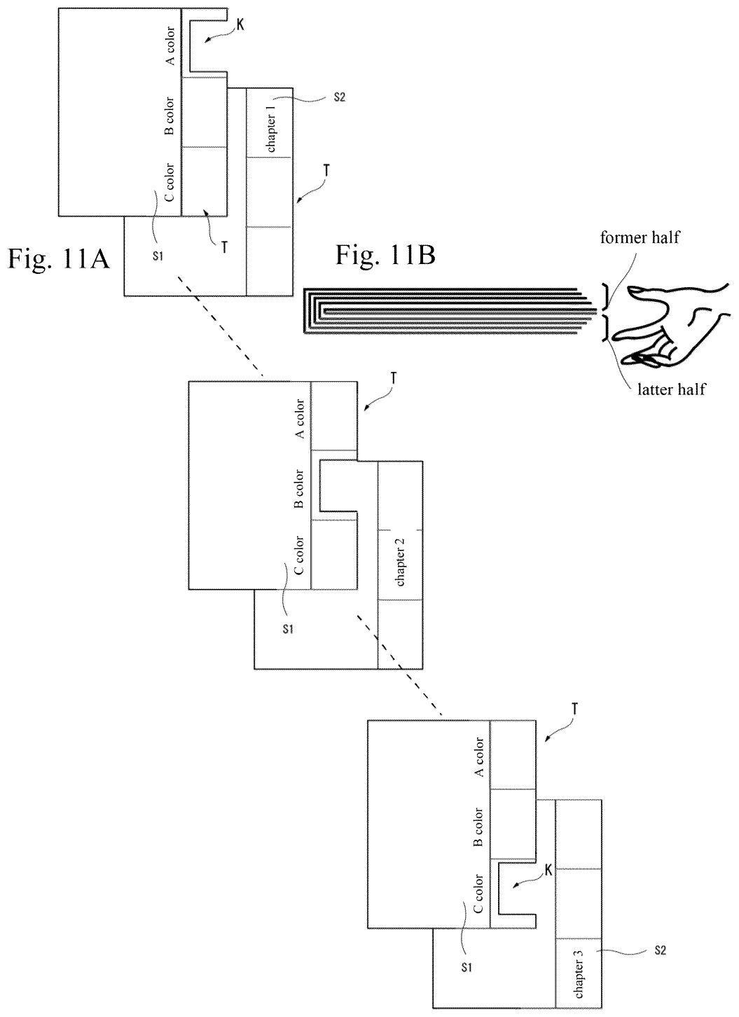

A post-processing apparatus according to the present embodiment will be described with reference to FIGS. 8 to 11. FIG. 8 is a schematic diagram of main parts of the post-processing apparatus, FIG. 9 is a diagram illustrating a combination of document sheets and index sheets, FIG. 10 is a diagram illustrating the document sheets and the index sheets of bookbinding, and FIGS. 11A and 11B are diagrams illustrating a booklet.

The post-processing apparatus is configured similarly to the post-processing apparatus according to the first embodiment. Here, the post-processing apparatus causes the document sheet S1 on which the document is formed and the index sheet S2 on which the chapter title is formed to overlap each other, and performs bookbinding such that the document sheet S1 can be identified for each chapter by the index sheet S2. Here, the document sheet S1 and the index sheet S2 include a colored portion T that can distinguish the chapters by different colors. The colored portions T can be distinguished by being given different colors such as A color, B color, and C color. In the document sheet S1, for example, the A color, the B color, the C color, and the like of the colored portions T of all the sheets are provided at the same position, in the index sheet S2, for example, the A color, the B color, the C color, and the like of the colored portions T of all the sheets are provided at the same position, and in the document sheet S1 and the index sheet S2, the A color, the B color, the C color, and the like are provided at the same position.

The image formation unit 20 forms the chapter title at the colored portion T of the index sheet S2 according to the chapter title information attached to the document based on the title setting function of the document generation software. The processing formation unit 30 forms the cut-out or cuttable portion-to-be-processed K at the colored portion T of the document sheet S1.

The bookbinding unit 40 causes the document sheet S1 on which the portion-to-be-processed K is formed and the index sheet S2 on which the chapter title is formed to overlap each other such that the document sheet S1 is positioned on the index sheet S2, and performs bookbinding while causing the portion-to-be-processed K of the document sheet S1 and the chapter title of the index sheet S2 to coincide with each other.

### Booklet

In the booklet, as illustrated in FIGS. 11A and 11B, the document sheet S1 on which the document is formed and the index sheet S2 on which the chapter title is formed are caused to overlap each other, and bookbinding is performed such that the document sheet S1 can be identified for each chapter by the index sheet S2. The document sheet S1 and the index sheet S2 have colored portions T that can distinguish the chapters by different colors.

The chapter title is formed at the colored portion T of the index sheet S2, the cut-out or cuttable portion-to-be-processed K is formed at the colored portion T of the document sheet S1, the document sheet S1 on which the portion-to-be-processed K is formed and the index sheet S2 on which the chapter title is formed are caused to overlap each other such that the document sheet S1 is positioned on the index sheet S2, and the portion-to-be-processed K of the document sheet S1 and the chapter title of the index sheet S2 are caused to coincide with each other, thereby performing bookbinding.

### Third Embodiment

### Post-Processing Apparatus

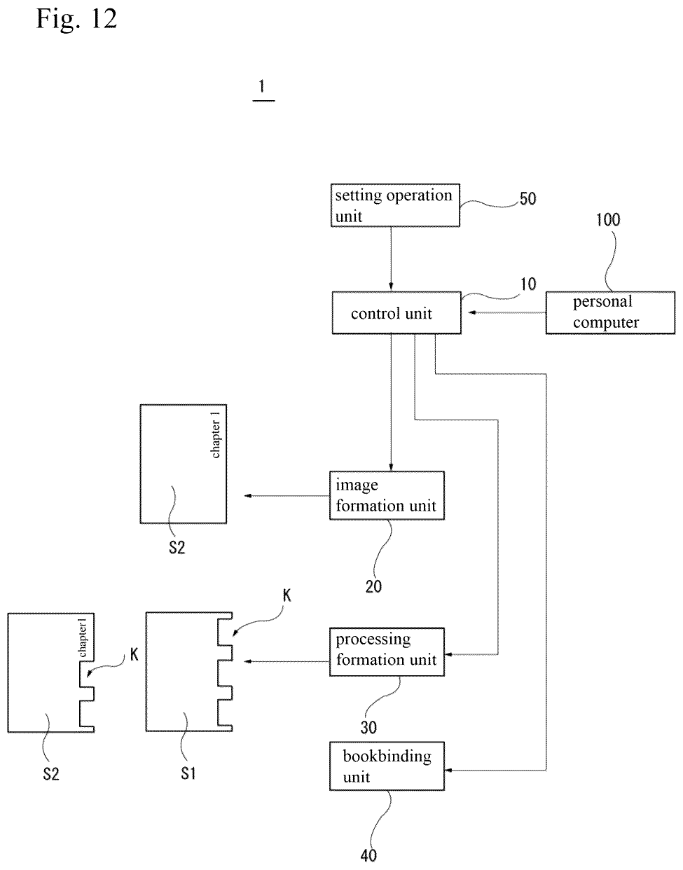

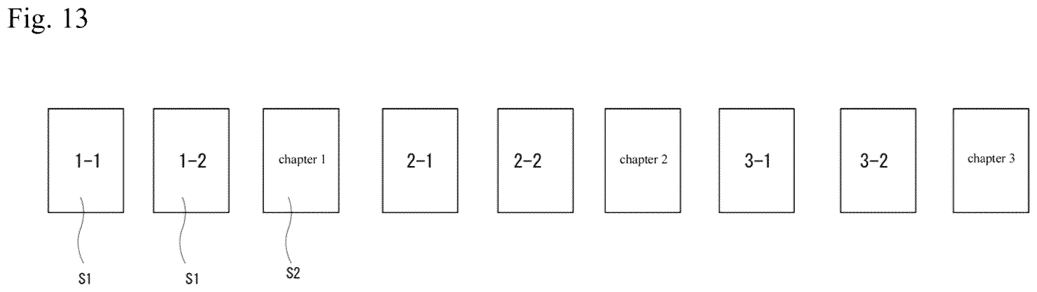

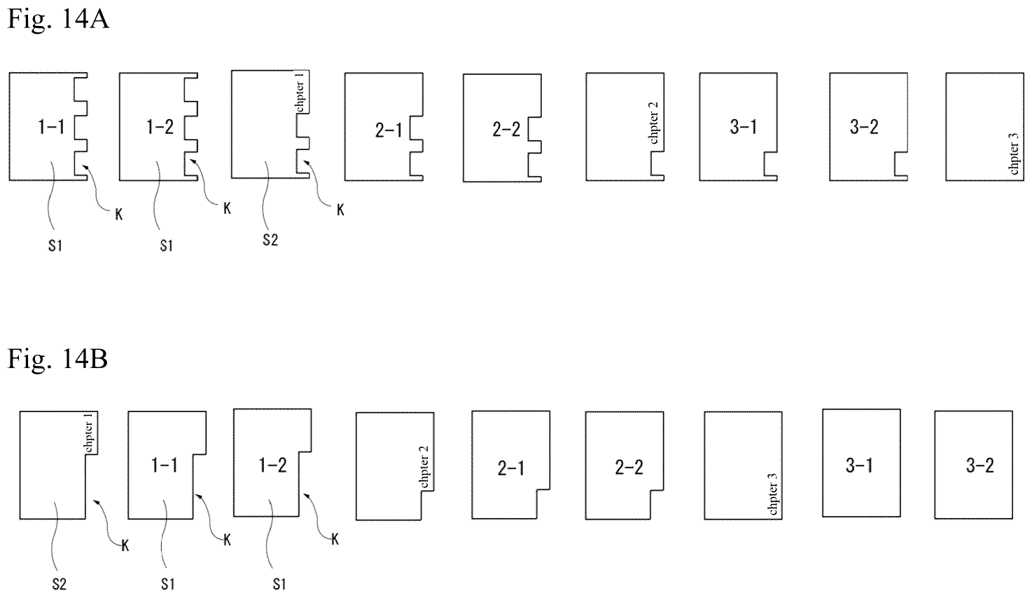

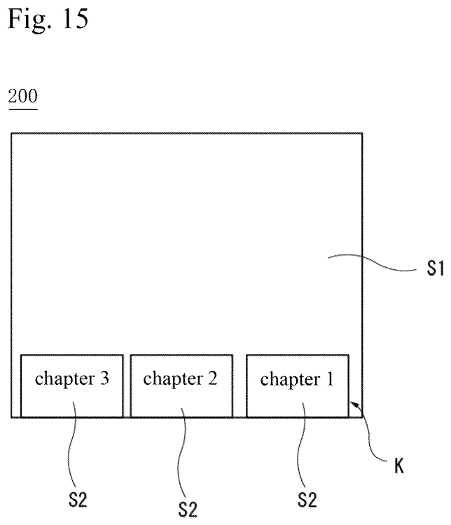

A post-processing apparatus will be described with reference to FIGS. 12 to 15. FIG. 12 is a schematic diagram of main parts of the post-processing apparatus, FIG. 13 is a diagram illustrating a combination of document sheets and index sheets, FIGS. 14A and 14B are diagrams illustrating the document sheets and the index sheets of bookbinding, and FIG. 15 is a plan view of a booklet.

Similarly to the post-processing apparatus 1 according to the first embodiment, the post-processing apparatus 1 includes the control unit 10, the image formation unit 20, the processing formation unit 30, and the bookbinding unit 40. The control unit 10 controls the image formation unit 20, the processing formation unit 30, and the bookbinding unit 40 based on information from the setting operation unit 50 and the personal computer 100. The processing formation unit 30 forms the portion-to-be-processed K on the document sheet S1 and forms the portion-to-be-processed K on the index sheet S2.

The bookbinding unit 40 causes the document sheet S1 on which the portion-to-be-processed K is formed and the index sheet S2 on which the chapter title is formed to overlap each other such that the document sheet S1 is positioned on the index sheet S2, and performs bookbinding while causing the portion-to-be-processed K of the document sheet S1 and the chapter title of the index sheet S2 to coincide with each other.

For example, as illustrated in FIGS. 14A and 14B, the image formation unit 20 generates a plurality of index sheets S2 on which chapter titles of Chapters 1, 2, and 3 are formed, and the respective index sheets S2 on which the chapter titles of Chapters 1, 2, and 3 are formed have different positions of the formed chapter titles of Chapters 1, 2, and 3.

The processing formation unit 30 forms the portion-to-be-processed K on the document sheet S1 according to the positions of the chapter titles of Chapter 1, Chapter 2, . . . formed on the index sheet S2 so that the document sheet S1 on which the document is formed can be identified for each chapter and forms the portion-to-be-processed K on the index sheet S2.

For example, for the document sheet S1 on which the document is formed to be able to be identified for each chapter from Chapters 1 to 3, as illustrated in FIGS. 14A and 14B, the portions-to-be-processed K (for example, three locations) are formed on two document sheets S1, and the portions-to-be-processed K (for example, two locations) are formed on the index sheet S2 on which the chapter title of Chapter 1 is formed.

The portions-to-be-processed K (for example, two locations) are formed on the next two document sheets S1, and the portion-to-be-processed K (for example, one location) is formed on the index sheet S2 on which the chapter title of Chapter 2 is formed. Further, the portion-to-be-processed K (for example, one location) is formed on the next two document sheets S1, and the position of the portion-to-be-processed K coincides with the position of the chapter title of the index sheet S2 on which the chapter title of Chapter 3 is formed.

In the bookbinding unit 40, as illustrated in FIGS. 14A and 14B, two document sheets S1 on which the portion-to-be-processed K is formed at the position of the chapter title of Chapter 3 is overlapped on the index sheet S2 on which the chapter title of Chapter 3 is formed. Further, the index sheet S2 on which the chapter title of Chapter 2 is formed is overlapped, the two document sheets S1 on which the portion-to-be-processed K is formed at the position of the chapter title of Chapter 2 are overlapped, the index sheet S2 on which the chapter title of Chapter 1 is formed is overlapped, two document sheets S1 on which the portion-to-be-processed K is formed at the position of the chapter title of Chapter 1 are overlapped, the portion-to-be-processed K of the document sheet S1 and the chapter title of the index sheet S2 are caused to coincide with each other, and bookbinding is performed to obtain the booklet 200 as illustrated in FIG. 15. The bookbinding of the booklet 200 is performed in various ways similarly to the first embodiment, and in the case of saddle-stitch bookbinding, there is an advantage in that the latter half pages of the booklet 200 are also easily turned over.

### Booklet

In the booklet, as illustrated in FIG. 15, the document sheet S1 on which the document is formed and the index sheet S2 on which the chapter title is formed are caused to overlap each other, and bookbinding is performed such that the document sheet S1 can be identified for each chapter by the index sheet S2. The chapter title is formed on the index sheet S2, the cut-out or cuttable portion-to-be-processed K is formed on the document sheet S1, and the cut-out or cuttable portion-to-be-processed K is formed on the index sheet S2. The document sheet S1 on which the portion-to-be-processed K is formed and the index sheet S2 on which the chapter title is formed are caused to overlap each other such that the document sheet S1 is positioned on the index sheet S2, and the portion-to-be-processed K of the document sheet S1 and the chapter title of the index sheet S2 are caused to coincide with each other, thereby performing bookbinding.

### Fourth Embodiment

### Post-Processing Apparatus

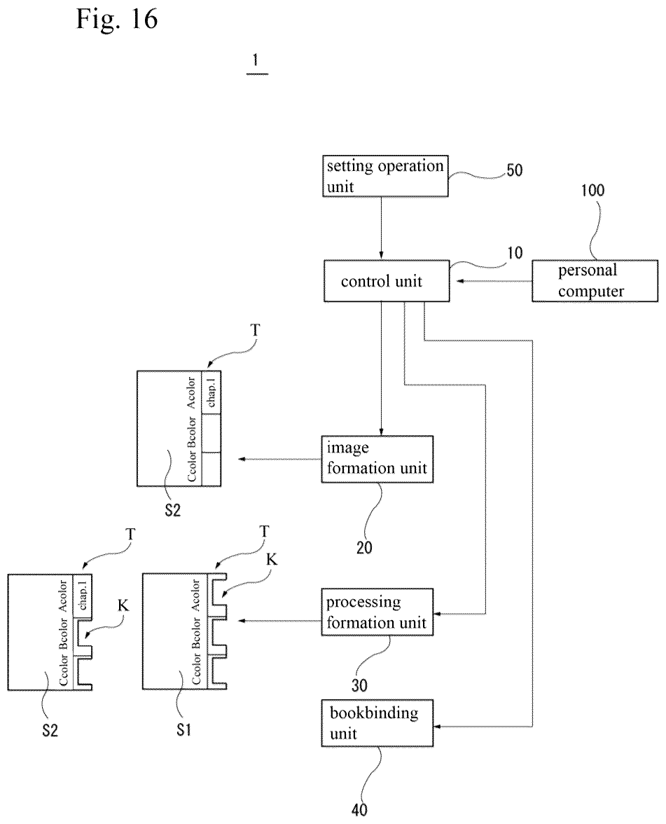

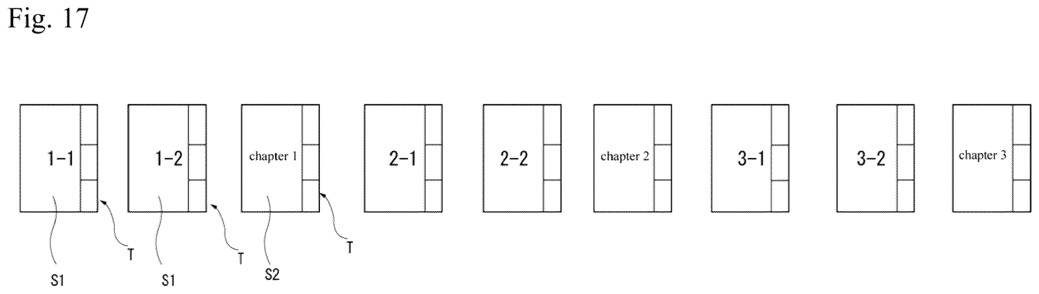

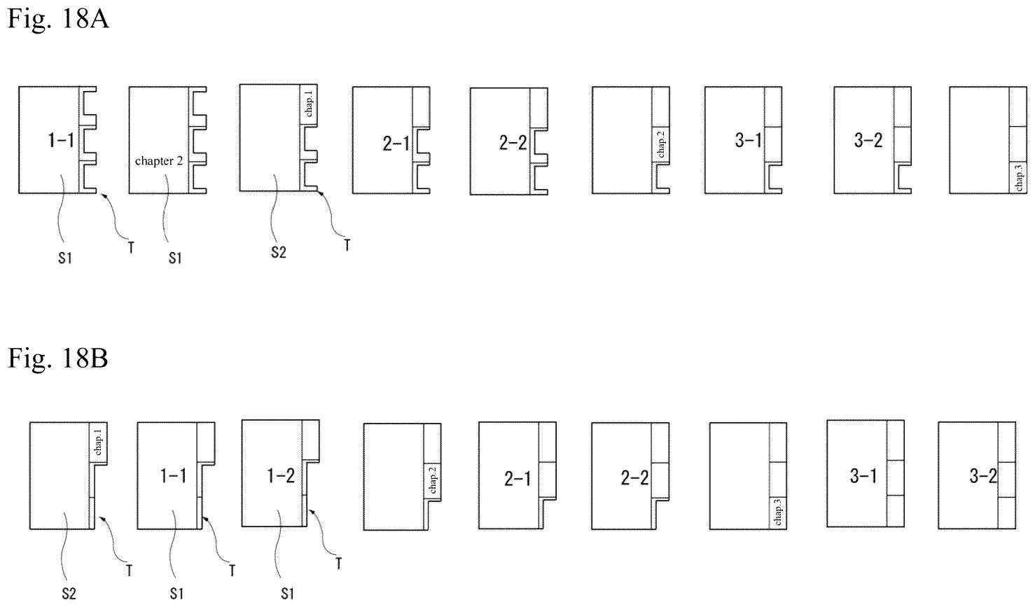

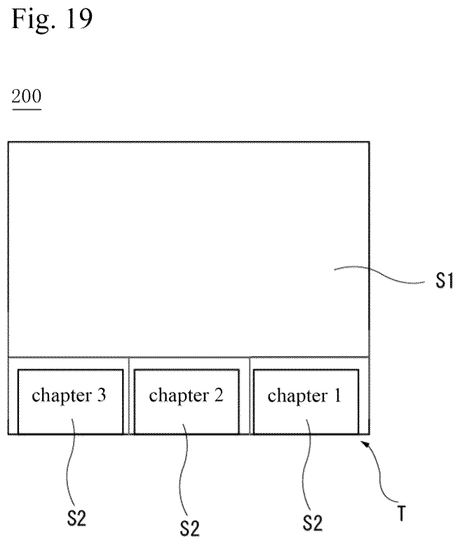

A post-processing apparatus will be described with reference to FIGS. 16 to 19. FIG. 16 is a schematic diagram of main parts of the post-processing apparatus, FIG. 17 is a diagram illustrating a combination of document sheets and index sheets, FIGS. 18A and 18B are diagrams illustrating the document sheets and the index sheets of bookbinding, and FIG. 19 is a diagram illustrating a booklet.

The post-processing apparatus is configured similarly to the post-processing apparatus according to the third embodiment. Here, the post-processing apparatus causes the document sheet S1 on which the document is formed and the index sheet S2 on which the chapter title is formed to overlap each other, and performs bookbinding such that the document sheet S1 can be identified for each chapter by the index sheet S2. Here, the document sheet S1 and the index sheet S2 include the colored portion T that can distinguish the chapters by different colors. The colored portions T can be distinguished by being given different colors such as A color, B color, and C color. In the document sheet S1, for example, the A color, the B color, the C color, and the like of the colored portions T of all the sheets are provided at the same position, in the index sheet S2, for example, the A color, the B color, the C color, and the like of the colored portions T of all the sheets are provided at the same position, and in the document sheet S1 and the index sheet S2, the A color, the B color, the C color, and the like are provided at the same position.

The image formation unit 20 forms the chapter title at the colored portion T of the index sheet S2 according to the chapter title information attached to the document based on the title setting function of the document generation software.

The processing formation unit 30 forms the cut-out or cuttable portion-to-be-processed K at the colored portion T of the document sheet S1, and forms the cut-out or cuttable portion-to-be-processed K at the colored portion T of the index sheet S2.

The bookbinding unit 40 causes the document sheet S1 on which the portion-to-be-processed K is formed and the index sheet S2 on which the chapter title is formed to overlap each other such that the document sheet S1 is positioned on the index sheet S2, and performs bookbinding while causing the portion-to-be-processed K of the document sheet S1 and the chapter title of the index sheet S2 to coincide with each other.

### Booklet

As illustrated in FIG. 19, the booklet is a booklet obtained by causing the document sheet S1 on which the document is formed and the index sheet S2 on which the chapter title is formed to overlap each other, and performing bookbinding such that the document sheet S1 can be identified for each chapter by the index sheet S2. Here, the document sheet S1 and the index sheet S2 include the colored portion T capable of distinguishing the chapters by different colors.

The chapter title is formed at the colored portion T of the index sheet S2, the cut-out or cuttable portion-to-be-processed K is formed at the colored portion T of the document sheet S1, and the cut-out or cuttable portion-to-be-processed K is formed at the colored portion T of the index sheet S2. The document sheet S1 on which the portion-to-be-processed K is formed and the index sheet S2 on which the chapter title is formed are caused to overlap each other such that the document sheet S1 is positioned on the index sheet S2, and the portion-to-be-processed K of the document sheet S1 and the chapter title of the index sheet S2 are caused to coincide with each other, thereby performing bookbinding.

### Fifth Embodiment

### Post-Processing Apparatus

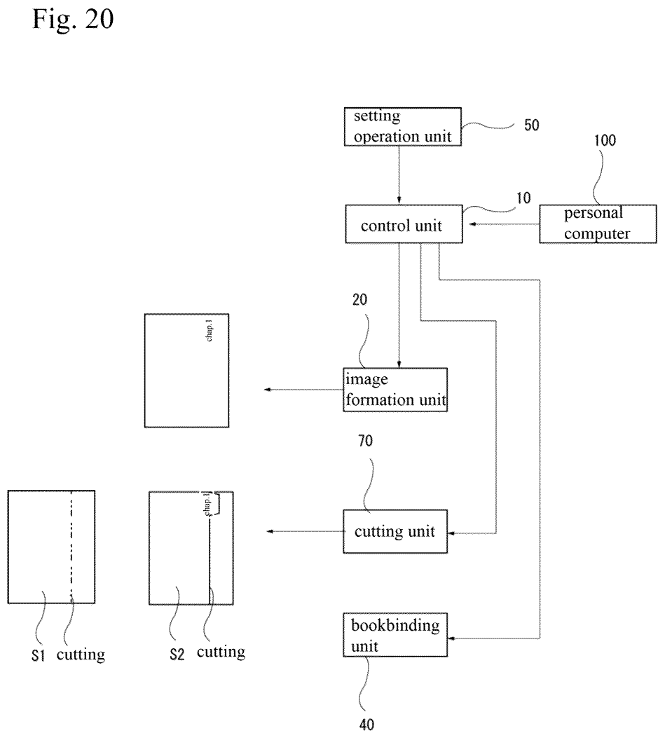

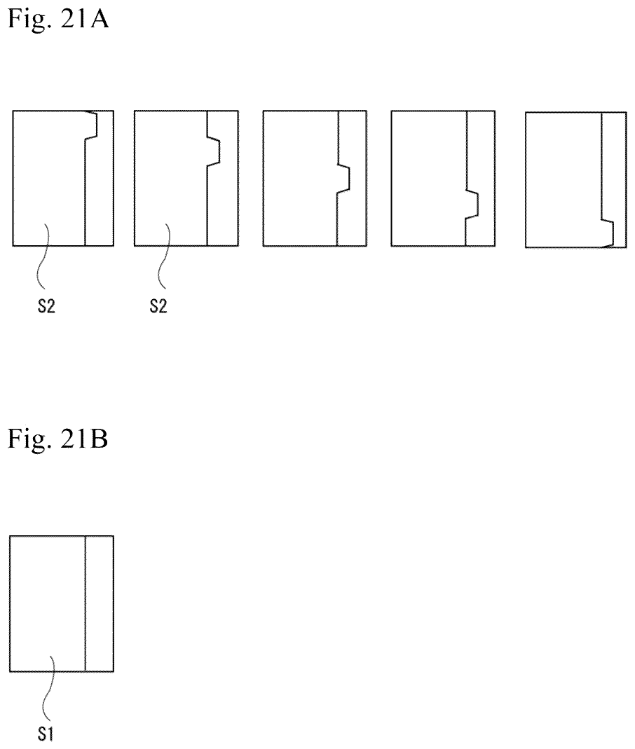

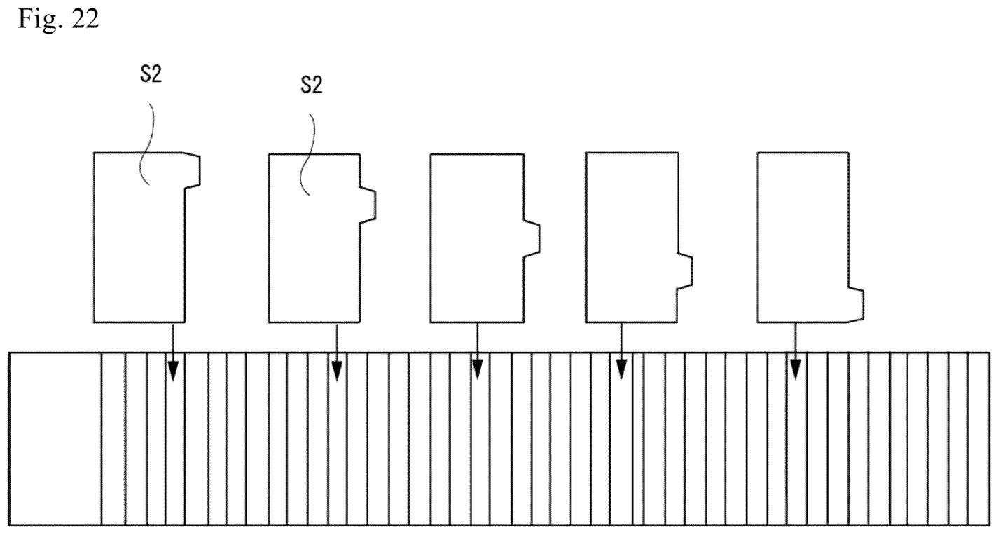

A post-processing apparatus will be described with reference to FIGS. 20 to 22. FIG. 20 is a schematic diagram of main parts of the post-processing apparatus, FIGS. 21A and 21B are diagrams illustrating document sheets and index sheets, and FIG. 22 is a diagram illustrating bookbinding.

The post-processing apparatus 1 includes the control unit 10, the image formation unit 20, a cutting unit 70, and the bookbinding unit 40, in which the control unit 10 and the image formation unit 20 are configured to be same as in the above-described embodiment, and the cutting unit 70 obtains the index sheet S2 having the chapter title by cutting, as illustrated in FIG. 21A, and cuts the document sheet S1 according to the size of the index sheet S2, as illustrated in FIG. 21B. As illustrated in FIG. 22, the bookbinding unit 40 performs bookbinding by overlapping the index sheet S2 generated by the cutting unit 70 and the document sheet S1 each other.

### Sixth Embodiment

### Post-Processing Apparatus

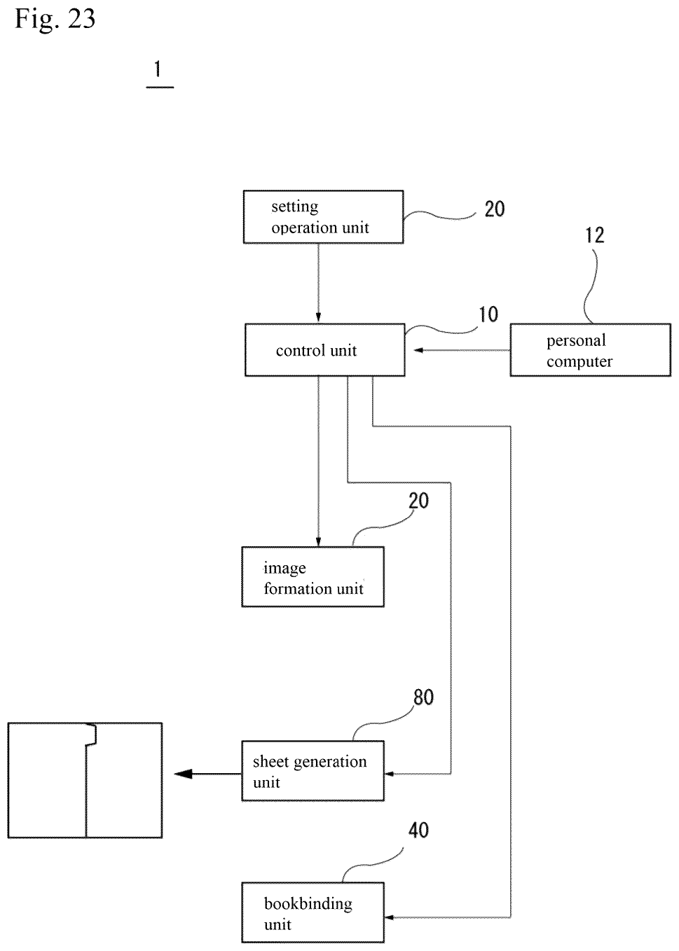

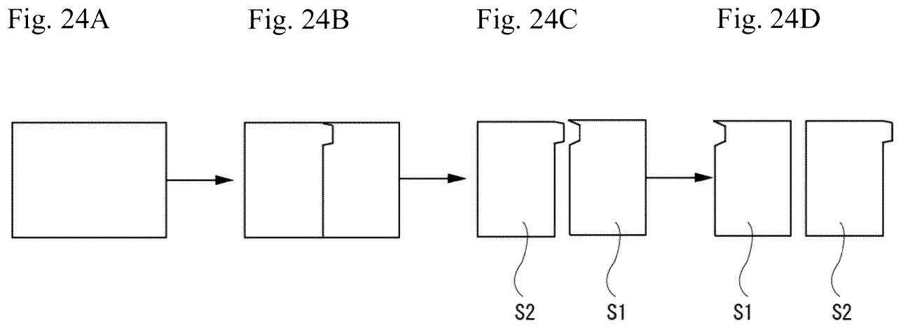

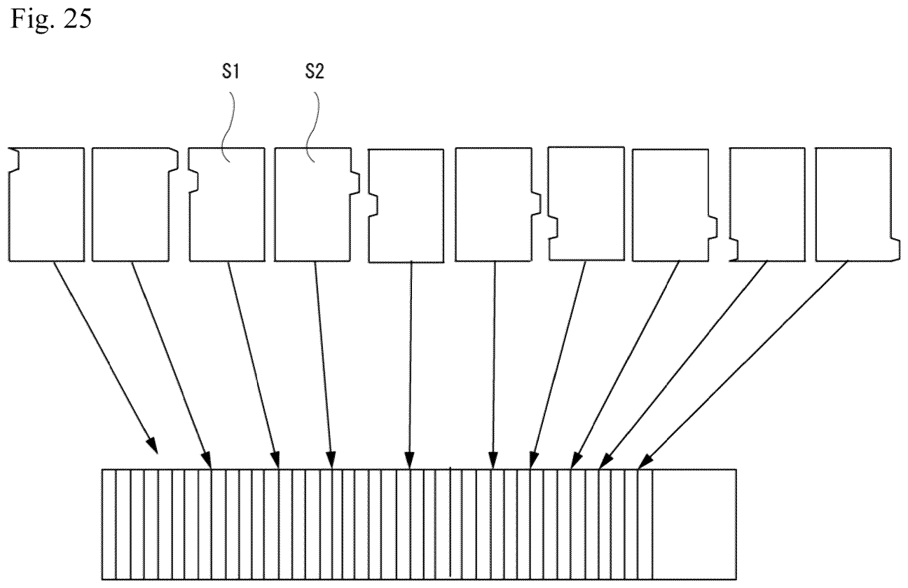

A post-processing apparatus will be described with reference to FIGS. 23 to 25. FIG. 23 is a schematic diagram of main parts of the post-processing apparatus, FIGS. 24A to 24D are diagrams illustrating document sheets and index sheets, and FIG. 25 is a diagram illustrating bookbinding.

The post-processing apparatus 1 includes the control unit 10, the image formation unit 20, a sheet generation unit 80, and the bookbinding unit 40, and the control unit 10 and the image formation unit 20 are configured to be same as in the above-described embodiment. As illustrated in FIGS. 24A to 24D, the sheet generation unit 80 divides a central position of a sheet of A3 size into two, for example, obtains the index sheet S2 having a protruding chapter title and the document sheet S1 having a notch formed by the protruding chapter title, and switches the index sheet S2 having the protruding chapter title and the document sheet S1 having the notch.

As illustrated in FIG. 25, the bookbinding unit 40 switches the index sheet S2 having the protruding chapter title and the document sheet S1 having the notch, causes the notch of the document sheet S1 to face a side opposite to the protruding chapter title of the index sheet S2, includes the other document sheet S1, and performs bookbinding by overlapping the index sheet S2 and the document sheet S1 each other.

### Seventh Embodiment

### Post-Processing Apparatus

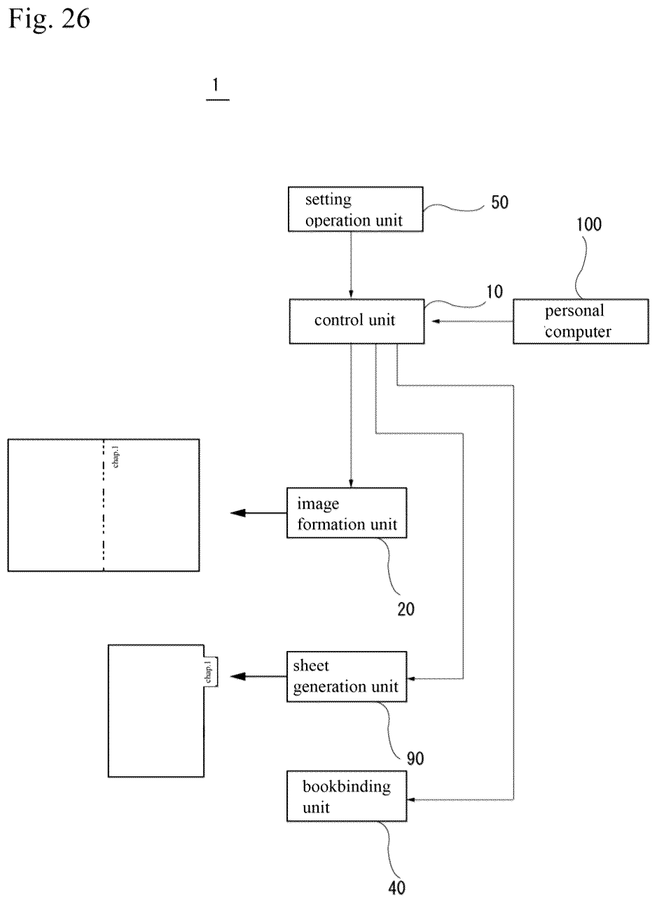

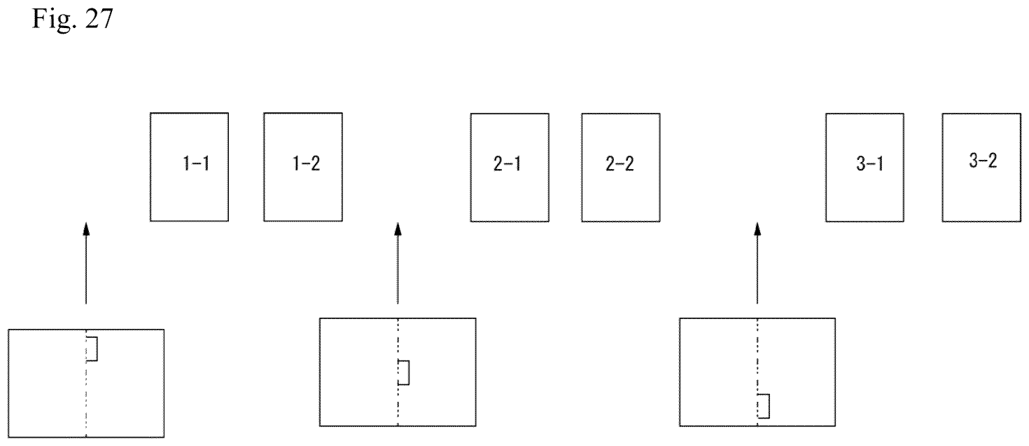

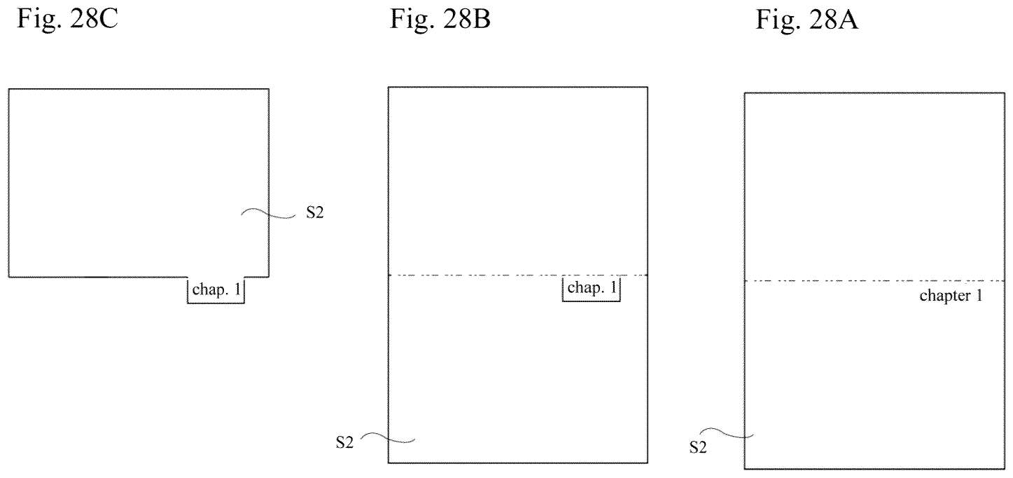

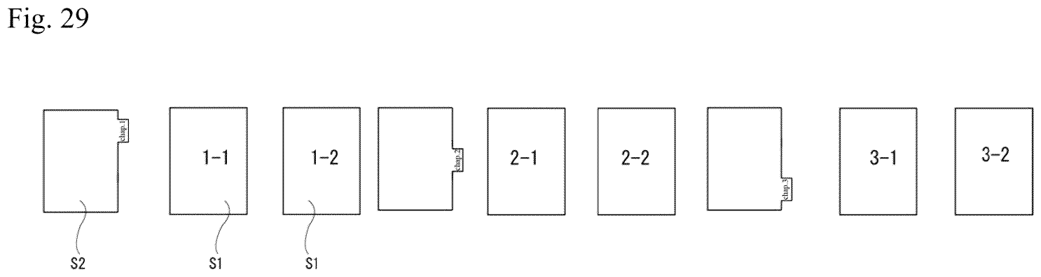

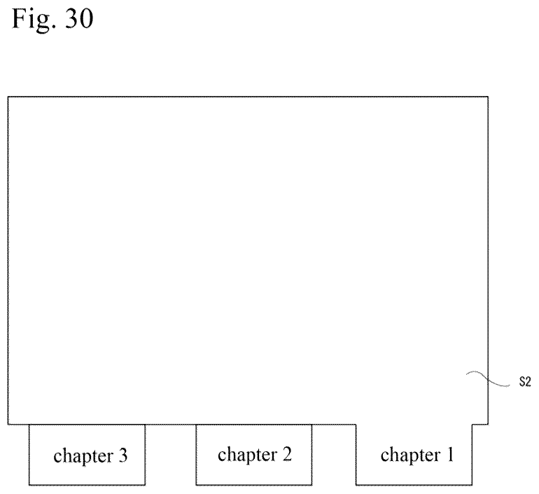

A post-processing apparatus will be described with reference to FIGS. 26 to 30. FIG. 26 is a schematic diagram of main parts of the post-processing apparatus, FIG. 27 is a diagram illustrating document sheets and index sheets, FIGS. 28A to 28C are diagrams illustrating generation of the index sheet, FIG. 29 is a diagram illustrating the document sheets and the index sheets of bookbinding, and FIG. 30 is a plan view of a booklet.

The post-processing apparatus 1 includes the control unit 10, the image formation unit 20, a sheet generation unit 90, and the bookbinding unit 40, and the control unit 10 and the image formation unit 20 are configured to be same as in the above embodiment. As illustrated in FIG. 27, a sheet having a size twice a size of the document sheet is used for generating the index sheet S2, and the image formation unit 20 forms the chapter title at a central position of the index sheet S2 according to the chapter title information attached to the document based on the title setting function of the document generation software.

As illustrated in FIG. 28A, the chapter title is formed at the central position of the index sheet S2, as illustrated in FIG. 28B, a notch is formed around the chapter title formed at the central position of the index sheet S2, and as illustrated in FIG. 28C, the sheet generation unit 90 obtains the index sheet S2 having the chapter title by folding the sheet in two.

As illustrated in FIGS. 29 and 30, the bookbinding unit 40 obtains the booklet 200 by overlapping the index sheet S2 and the document sheet S1 each other such that the index sheet S2 is positioned on the document sheet S1 and performing bookbinding.

### Eighth Embodiment

### Post-Processing Apparatus

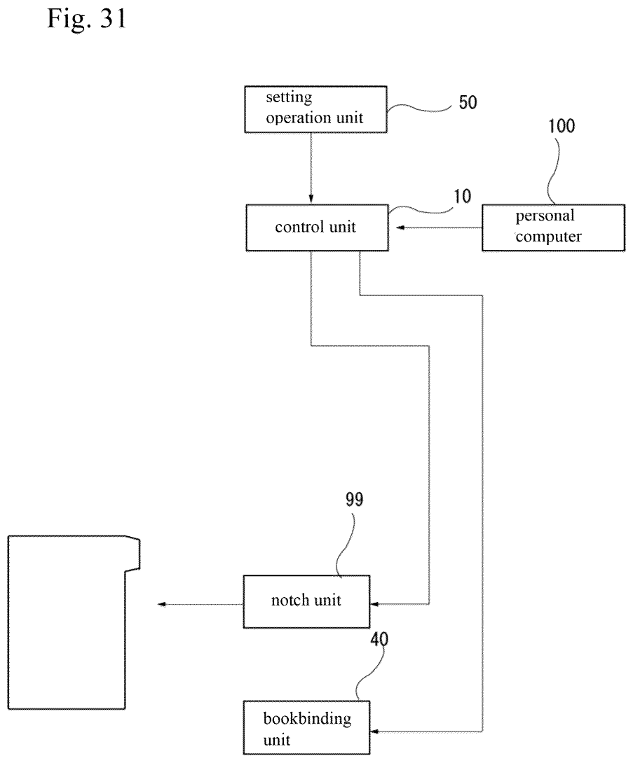

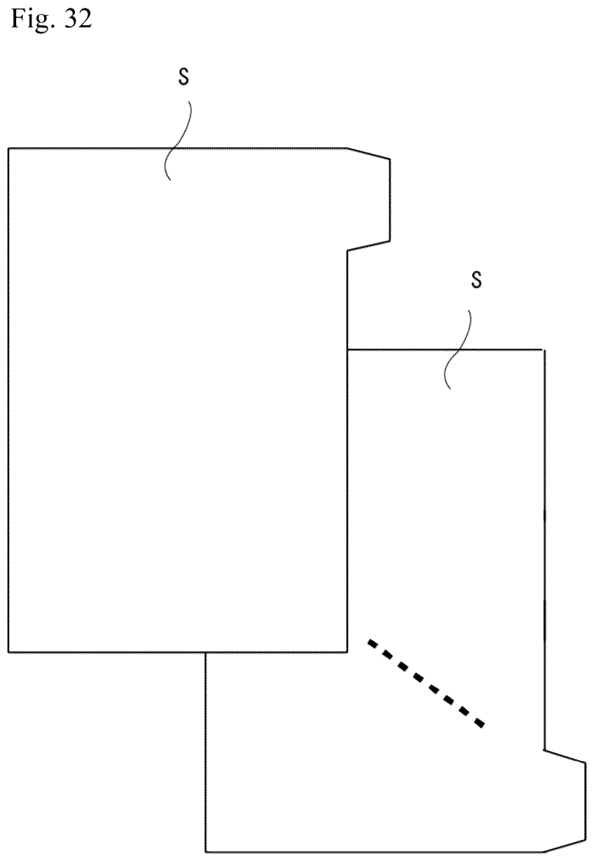

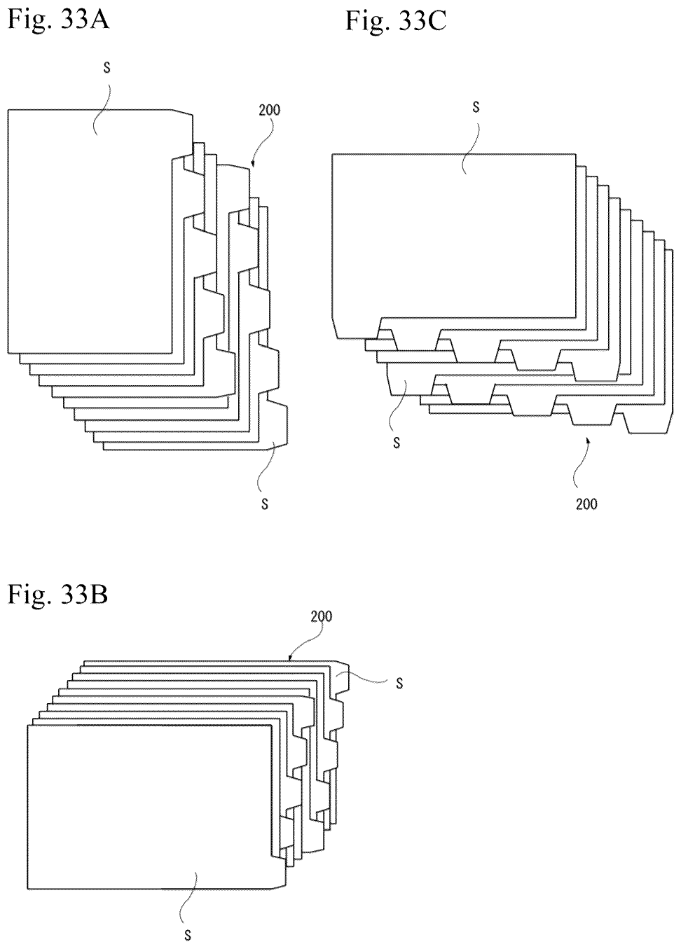

A post-processing apparatus will be described with reference to FIGS. 31 to 33. FIG. 31 is a schematic diagram of main parts of the post-processing apparatus, FIG. 32 is a diagram illustrating generated sheets, and FIGS. 33A to 33C are diagrams illustrating bookbinding of sheets.

The post-processing apparatus 1 includes the setting operation unit 50, the control unit 10, a notch unit 99, and the bookbinding unit 40, in which the control unit 10 and the setting operation unit 50 are configured to be same as in the above-described embodiment, and as illustrated in FIG. 32, the notch unit 99 forms a protruding title by changing a notched position for each of the plurality of sheets S.

As illustrated in FIGS. 33A to 33C, the bookbinding unit 40 performs bookbinding by overlapping the plurality of sheets S each having a protruding title formed thereon such that the titles protruding one by one are arranged, and in the bookbinding, as illustrated in FIG. 33A, the title protruding to the long side of the sheet S may be formed, or as illustrated in FIG. 33B, the title protruding to the short side may be formed. As illustrated in FIG. 33C, the long side of the sheet S may be turned sideways to form a title protruding to the long side.

As such, bookbinding is performed by overlapping the plurality of sheets S respectively having the protruding titles formed thereon such that the titles protruding one by one are arranged, whereby the booklet can be easily turned over and opened one by one by the titles protruding one by one, and as illustrated in FIG. 33C, particularly, the latter half pages of the saddle bookbinding can be easily turned over.

### Ninth Embodiment

### Booklet

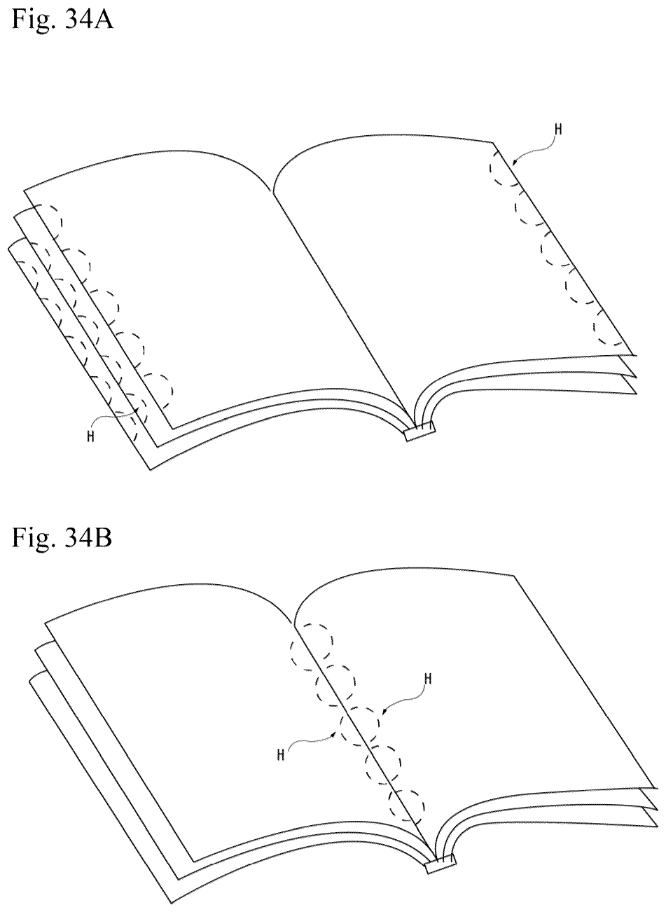

A booklet will be described with reference to FIGS. 34A and 34B. FIGS. 34A and 34B are diagrams illustrating a state in which a document sheet of the booklet is opened. The booklet is obtained by binding document sheets each having a document formed thereon. In the form of FIG. 34A, a portion-to-be-processed H including holes formed along a line is provided on an opening side of the booklet. In the form of FIG. 34B, the portion-to-be-processed H including holes formed along a line is provided on a binding side of the booklet. The portion-to-be-processed H is, for example, a perforation or three remaining points.

In the form of FIG. 34A, since the portion-to-be-processed H is provided on the opening side of the booklet, resistance force of the finger turning over the page by the portion-to-be-processed H increases, and the page is easily turned over. In the form of FIG. 34B, since the portion-to-be-processed H is provided on the binding side of the booklet, an adhesive dissolved during bookbinding easily penetrates into the booklet from the portion-to-be-processed H, and the booklet becomes a booklet with a firm binding side.

### Industrial Applicability

The present invention can be applied to a post-processing apparatus that generates a booklet including a sheet on which a document is printed and an index sheet, and the booklet obtained by binding the document sheets each having the document formed thereon. With a simple configuration, bookbinding is performed such that the document sheet can be identified for each chapter by the index sheet, and a predetermined sheet can be easily turned over and opened.

### Reference Signs List

S1 Document sheet
S2 Index sheet
1 Post-processing apparatus
10 Control unit
20 Image formation unit
30 Processing formation unit
30a Plurality of blades
30b Base
40 Bookbinding unit
50 Setting operation unit
70 Cutting unit
80, 90 Sheet generation unit
200 Booklet

1. A post-processing apparatus adapted to cause a document sheet having a document formed thereon and an index sheet having a chapter title formed thereon to overlap each other, and to perform bookbinding such that the document sheet is identifiable for each chapter by the index sheet, the post-processing apparatus comprising:
an image formation unit configured to form, based on a title setting function provided in document generation software, the chapter title on the index sheet according to chapter title information attached to the document;
a processing formation unit configured to form a cut-out or cuttable portion-to-be-processed on the document sheet; and
a bookbinding unit configured to cause the document sheet having the portion-to-be-processed formed thereon and the index sheet having the chapter title formed thereon to overlap each other such that the document sheet is positioned on the index sheet, and to perform the bookbinding by causing the portion-to-be-processed of the document sheet and the chapter title of the index sheet to coincide with each other.

2. A post-processing apparatus adapted to cause a document sheet having a document formed thereon and an index sheet having a chapter title formed thereon to overlap each other, and to perform bookbinding such that the document sheet is identifiable for each chapter by the index sheet, the post-processing apparatus comprising:
a colored portion included in the document sheet and the index sheet, the colored portion being capable of distinguishing chapters by different colors;
an image formation unit configured to form, based on a title setting function provided in document generation software, the chapter title at the colored portion of the index sheet according to chapter title information attached to the document;
a processing formation unit configured to form a cut-out or cuttable portion-to-be-processed at the colored portion of the document sheet; and
a bookbinding unit configured to cause the document sheet having the portion-to-be-processed formed thereon and the index sheet having the chapter title formed thereon to overlap each other such that the document sheet is positioned on the index sheet, and to perform the bookbinding by causing the portion-to-be-processed of the document sheet and the chapter title of the index sheet to coincide with each other.

3. A post-processing apparatus adapted to cause a document sheet having a document formed thereon and an index sheet having a chapter title formed thereon to overlap each other, and to perform bookbinding such that the document sheet is identifiable for each chapter by the index sheet, the post-processing apparatus comprising:
an image formation unit configured to form, based on a title setting function provided in document generation software, the chapter title on the index sheet according to chapter title information attached to the document;
a processing formation unit configured to form a cut-out or cuttable portion-to-be-processed on the document sheet and to form the cut-out or cuttable portion-to-be-processed on the index sheet; and
a bookbinding unit configured to cause the document sheet having the portion-to-be-processed formed thereon and the index sheet having the chapter title formed thereon to overlap each other such that the document sheet is positioned on the index sheet, and to perform the bookbinding by causing the portion-to-be-processed of the document sheet and the chapter title of the index sheet to coincide with each other.

4. A post-processing apparatus adapted to cause a document sheet having a document formed thereon and an index sheet having a chapter title formed thereon to overlap each other, and to perform bookbinding such that the document sheet is identifiable for each chapter by the index sheet, the post-processing apparatus comprising:
a colored portion included in the document sheet and the index sheet, the colored portion being capable of distinguishing chapters by different colors;
an image formation unit configured to form, based on a title setting function provided in document generation software, the chapter title at the colored portion of the index sheet according to chapter title information attached to the document;
a processing formation unit configured to form a cut-out or cuttable portion-to-be-processed at the colored portion of the document sheet and to form the cut-out or cuttable portion-to-be-processed at the colored portion of the index sheet; and
a bookbinding unit configured to cause the document sheet having the portion-to-be-processed formed thereon and the index sheet having the chapter title formed thereon to overlap each other such that the document sheet is positioned on the index sheet, and to perform the bookbinding by causing the portion-to-be-processed of the document sheet and the chapter title of the index sheet to coincide with each other.

5. A post-processing apparatus adapted to cause a document sheet having a document formed thereon and an index sheet having a chapter title formed thereon to overlap each other, and to perform bookbinding such that the document sheet is identifiable for each chapter by the index sheet, the post-processing apparatus comprising:
an image formation unit configured to form, based on a title setting function provided in document generation software, the chapter title on the index sheet according to chapter title information attached to the document;
a cutting unit configured to obtain the index sheet having the chapter title and to cut the document sheet in accordance with a size of the index sheet; and
a bookbinding unit configured to perform the bookbinding by overlapping the index sheet and the document sheet each other.

6. A post-processing apparatus adapted to cause a document sheet having a document formed thereon and an index sheet having a chapter title formed thereon to overlap each other, and to perform bookbinding such that the document sheet is identifiable for each chapter by the index sheet, the post-processing apparatus comprising:
an image formation unit configured to form, based on a title setting function provided in document generation software, the chapter title on the index sheet according to chapter title information attached to the document;
a sheet generation unit configured to divide a central position of a sheet into two so as to obtain an index sheet having a protruding chapter title and a document sheet having a notch formed by the protruding chapter title; and
a bookbinding unit configured to replace the index sheet having the protruding chapter title and the document sheet having the notch, to cause the notch of the document sheet to face a side opposite to the protruding chapter title of the index sheet, and to perform the bookbinding by overlapping the index sheet and the document sheet each other such that the index sheet is positioned on the document sheet.

7. A post-processing apparatus adapted to cause a document sheet having a document formed thereon and an index sheet having a chapter title formed thereon to overlap each other, and to perform bookbinding such that the document sheet is identifiable for each chapter by the index sheet, the post-processing apparatus comprising:
an image formation unit configured to form, based on a title setting function provided in document generation software, the chapter title at a central position of the index sheet according to chapter title information attached to the document;
an index sheet generation unit configured to form a notch around the chapter title formed at the central position of the index sheet and to fold the sheet in two so as to obtain the index sheet having the chapter title; and
a bookbinding unit configured to perform the bookbinding by overlapping the index sheet and the document sheet each other such that the index sheet is positioned on the document sheet.

8. The post-processing apparatus according to any one of claims 1 to 4, wherein
the processing formation unit includes
a blade adapted to form a plurality of the cut-out or cuttable portions-to-be-processed corresponding to a position at which the portion-to-be-processed on the document sheet is to be formed, and
each of the plurality of blades moves based on selection so as to form the portion-to-be-processed on the document sheet at a predetermined position.

9. A post-processing apparatus adapted to perform bookbinding such that a plurality of sheets are identifiable, the post-processing apparatus comprising:
a notch unit adapted to form a title protruding by changing a notched position one by one for the plurality of sheets; and
a bookbinding unit configured to bind the plurality of sheets each having the protruding title formed thereon such that the protruding titles are arranged one by one.

10. A booklet obtained by causing a document sheet having a document formed thereon and an index sheet having a chapter title formed thereon to overlap each other and performing bookbinding such that the document sheet is identifiable for each chapter by the index sheet, wherein:
a cut-out or cuttable portion-to-be-processed is formed on the document sheet, and
the document sheet having the portion-to-be-processed formed thereon and the index sheet having the chapter title formed thereon overlap each other such that the document sheet is positioned on the index sheet, and the bookbinding is performed by causing the portion-to-be-processed of the document sheet and the chapter title of the index sheet to coincide with each other.

11. A booklet obtained by causing a document sheet having a document formed thereon and an index sheet having a chapter title formed thereon to overlap each other and performing bookbinding such that the document sheet is identifiable for each chapter by the index sheet, wherein
the document sheet and the index sheet include a colored portion capable of distinguishing chapters by different colors,
the chapter title is formed at the colored portion of the index sheet,
a cut-out or cuttable portion-to-be-processed is formed at the colored portion of the document sheet, and
the document sheet having the portion-to-be-processed formed thereon and the index sheet having the chapter title formed thereon overlap each other such that the document sheet is positioned on the index sheet, and the bookbinding is performed by causing the portion-to-be-processed of the document sheet and the chapter title of the index sheet to coincide with each other.

12. A booklet obtained by causing a document sheet having a document formed thereon and an index sheet having a chapter title formed thereon to overlap each other and performing bookbinding such that the document sheet is identifiable for each chapter by the index sheet, wherein
the chapter title is formed on the index sheet,
a cut-out or cuttable portion-to-be-processed is formed on the document sheet, and the cut-out or cuttable portion-to-be-processed is formed on the index sheet, and
the document sheet having the portion-to-be-processed formed thereon and the index sheet having the chapter title formed thereon overlap each other such that the document sheet is positioned on the index sheet, and the bookbinding is performed by causing the portion-to-be-processed of the document sheet and the chapter title of the index sheet to coincide with each other.

13. A booklet obtained by causing a document sheet having a document formed thereon and an index sheet having a chapter title formed thereon to overlap each other and performing bookbinding such that the document sheet is identifiable for each chapter by the index sheet, wherein
the document sheet and the index sheet include a colored portion capable of distinguishing chapters by different colors,
the chapter title is formed at the colored portion of the index sheet,
a cut-out or cuttable portion-to-be-processed is formed at the colored portion of the document sheet, and the cut-out or cuttable portion-to-be-processed is formed at the colored portion of the index sheet, and
the document sheet having the portion-to-be-processed formed thereon and the index sheet having the chapter title formed thereon overlap each other such that the document sheet is positioned on the index sheet, and the bookbinding is performed by causing the portion-to-be-processed of the document sheet and the chapter title of the index sheet to coincide with each other.

14. A booklet obtained by binding document sheets each having a document formed thereon, wherein
a portion-to-be-processed including holes formed along a line is provided
on a binding side of the booklet or an opening side of the booklet.

1 . . . ] A post-processing apparatus adapted to cause a document sheet having a document formed thereon and an index sheet having a chapter title formed thereon to overlap each other, and to perform bookbinding such that the document sheet is identifiable for each chapter by the index sheet, the post-processing apparatus comprising:
an image formation unit configured to form, based on a title setting function provided in document generation software, the chapter title on the index sheet according to chapter title information attached to the document;
a processing formation unit configured to form a cut- out or cuttable portion-to-be-processed on the document sheet; and
a bookbinding unit configured to cause the document sheet having the portion-to-be-processed formed thereon and the index sheet having the chapter title formed thereon to overlap each other such that the document sheet is positioned on the index sheet, and to perform the bookbinding by causing the portion-to-be-processed of the document sheet and the chapter title of the index sheet to coincide with each other.

2 . . . ] A post-processing apparatus adapted to cause a document sheet having a document formed thereon and an index sheet having a chapter title formed thereon to overlap each other, and to perform bookbinding such that the document sheet is identifiable for each chapter by the index sheet, the post-processing apparatus comprising:
a colored portion included in the document sheet and the index sheet, the colored portion being capable of distinguishing chapters by different colors;
an image formation unit configured to form, based on a title setting function provided in document generation software, the chapter title at the colored portion of the index sheet according to chapter title information attached to the document;
a processing formation unit configured to form a cut- out or cuttable portion-to-be-processed at the colored portion of the document sheet; and
a bookbinding unit configured to cause the document sheet having the portion-to-be-processed formed thereon and the index sheet having the chapter title formed thereon to overlap each other such that the document sheet is positioned on the index sheet, and to perform the bookbinding by causing the portion-to-be-processed of the document sheet and the chapter title of the index sheet to coincide with each other.

3 . . . ] A post-processing apparatus adapted to cause a document sheet having a document formed thereon and an index sheet having a chapter title formed thereon to overlap each other, and to perform bookbinding such that the document sheet is identifiable for each chapter by the index sheet, the post-processing apparatus comprising:
an image formation unit configured to form, based on a title setting function provided in document generation software, the chapter title on the index sheet according to chapter title information attached to the document;
a processing formation unit configured to form a cut- out or cuttable portion-to-be-processed on the document sheet and to form the cut-out or cuttable portion-to-be- processed on the index sheet; and
a bookbinding unit configured to cause the document sheet having the portion-to-be-processed formed thereon and the index sheet having the chapter title formed thereon to overlap each other such that the document sheet is positioned on the index sheet, and to perform the bookbinding by causing the portion-to-be-processed of the document sheet and the chapter title of the index sheet to coincide with each other.

4 . . . ] A post-processing apparatus adapted to cause a document sheet having a document formed thereon and an index sheet having a chapter title formed thereon to overlap each other, and to perform bookbinding such that the document sheet is identifiable for each chapter by the index sheet, the post-processing apparatus comprising:
a colored portion included in the document sheet and the index sheet, the colored portion being capable of distinguishing chapters by different colors;
an image formation unit configured to form, based on a title setting function provided in document generation software, the chapter title at the colored portion of the index sheet according to chapter title information attached to the document;
a processing formation unit configured to form a cut- out or cuttable portion-to-be-processed at the colored portion of the document sheet and to form the cut-out or cuttable portion-to-be-processed at the colored portion of the index sheet; and
a bookbinding unit configured to cause the document sheet having the portion-to-be-processed formed thereon and the index sheet having the chapter title formed thereon to overlap each other such that the document sheet is positioned on the index sheet, and to perform the bookbinding by causing the portion-to-be-processed of the document sheet and the chapter title of the index sheet to coincide with each other.

5 . . . ] A post-processing apparatus adapted to cause a document sheet having a document formed thereon and an index sheet having a chapter title formed thereon to overlap each other, and to perform bookbinding such that the document sheet is identifiable for each chapter by the index sheet, the post-processing apparatus comprising:
an image formation unit configured to form, based on a title setting function provided in document generation software, the chapter title on the index sheet according to chapter title information attached to the document;
a cutting unit configured to obtain the index sheet having the chapter title and to cut the document sheet in accordance with a size of the index sheet; and
a bookbinding unit configured to perform the bookbinding by overlapping the index sheet and the document sheet each other.

6 . . . ] A post-processing apparatus adapted to cause a document sheet having a document formed thereon and an index sheet having a chapter title formed thereon to overlap each other, and to perform bookbinding such that the document sheet is identifiable for each chapter by the index sheet, the post-processing apparatus comprising:
an image formation unit configured to form, based on a title setting function provided in document generation software, the chapter title on the index sheet according to chapter title information attached to the document;
a sheet generation unit configured to divide a central position of a sheet into two so as to obtain an index sheet having a protruding chapter title and a document sheet having a notch formed by the protruding chapter title; and
a bookbinding unit configured to replace the index sheet having the protruding chapter title and the document sheet having the notch, to cause the notch of the document sheet to face a side opposite to the protruding chapter title of the index sheet, and to perform the bookbinding by overlapping the index sheet and the document sheet each other such that the index sheet is positioned on the document sheet.

7 . . . ] A post-processing apparatus adapted to cause a document sheet having a document formed thereon and an index sheet having a chapter title formed thereon to overlap each other, and to perform bookbinding such that the document sheet is identifiable for each chapter by the index sheet, the post-processing apparatus comprising:
an image formation unit configured to form, based on a title setting function provided in document generation software, the chapter title at a central position of the index sheet according to chapter title information attached to the document;
an index sheet generation unit configured to form a notch around the chapter title formed at the central position of the index sheet and to fold the sheet in two so as to obtain the index sheet having the chapter title; and
a bookbinding unit configured to perform the bookbinding by overlapping the index sheet and the document sheet each other such that the index sheet is positioned on the document sheet.

8 . . . ] The post-processing apparatus according to any one of claims 1 to 4, wherein the processing formation unit includes a blade adapted to form a plurality of the cut-out or cuttable portions-to-be-processed corresponding to a position at which the portion-to-be-processed on the document sheet is to be formed, and each of the plurality of blades moves based on selection so as to form the portion-to-be-processed on the document sheet at a predetermined position.

9 . . . ] A post-processing apparatus adapted to perform bookbinding such that a plurality of sheets are identifiable, the post-processing apparatus comprising:
a notch unit adapted to form a title protruding by changing a notched position one by one for the plurality of sheets; and
a bookbinding unit configured to bind the plurality of sheets each having the protruding title formed thereon such that the protruding titles are arranged one by one.

10 . . . ] A booklet obtained by causing a document sheet having a document formed thereon and an index sheet having a chapter title formed thereon to overlap each other and performing bookbinding such that the document sheet is identifiable for each chapter by the index sheet, wherein:
a cut-out or cuttable portion-to-be-processed is formed on the document sheet, and the document sheet having the portion-to-be-processed formed thereon and the index sheet having the chapter title formed thereon overlap each other such that the document sheet is positioned on the index sheet, and the bookbinding is performed by causing the portion-to-be-processed of the document sheet and the chapter title of the index sheet to coincide with each other.

11 . . . ] A booklet obtained by causing a document sheet having a document formed thereon and an index sheet having a chapter title formed thereon to overlap each other and performing bookbinding such that the document sheet is identifiable for each chapter by the index sheet, wherein the document sheet and the index sheet include a colored portion capable of distinguishing chapters by different colors, the chapter title is formed at the colored portion of the index sheet, a cut-out or cuttable portion-to-be-processed is formed at the colored portion of the document sheet, and the document sheet having the portion-to-be-processed formed thereon and the index sheet having the chapter title formed thereon overlap each other such that the document sheet is positioned on the index sheet, and the bookbinding is performed by causing the portion-to-be-processed of the document sheet and the chapter title of the index sheet to coincide with each other.

12 . . . ] A booklet obtained by causing a document sheet having a document formed thereon and an index sheet having a chapter title formed thereon to overlap each other and performing bookbinding such that the document sheet is identifiable for each chapter by the index sheet, wherein the chapter title is formed on the index sheet, a cut-out or cuttable portion-to-be-processed is formed on the document sheet, and the cut-out or cuttable portion- to-be-processed is formed on the index sheet, and the document sheet having the portion-to-be-processed formed thereon and the index sheet having the chapter title formed thereon overlap each other such that the document sheet is positioned on the index sheet, and the bookbinding is performed by causing the portion-to-be-processed of the document sheet and the chapter title of the index sheet to coincide with each other.

13 . . . ] A booklet obtained by causing a document sheet having a document formed thereon and an index sheet having a chapter title formed thereon to overlap each other and performing bookbinding such that the document sheet is identifiable for each chapter by the index sheet, wherein the document sheet and the index sheet include a colored portion capable of distinguishing chapters by different colors, the chapter title is formed at the colored portion of the index sheet, a cut-out or cuttable portion-to-be-processed is formed at the colored portion of the document sheet, and the cut- out or cuttable portion-to-be-processed is formed at the colored portion of the index sheet, and the document sheet having the portion-to-be-processed formed thereon and the index sheet having the chapter title formed thereon overlap each other such that the document sheet is positioned on the index sheet, and the bookbinding is performed by causing the portion-to-be-processed of the document sheet and the chapter title of the index sheet to coincide with each other.

14 . . . ] A booklet obtained by binding document sheets each having a document formed thereon, wherein a portion-to-be-processed including holes formed along a line is provided on a binding side of the booklet or an opening side of the booklet.
